(19) United States
(12) Patent Application Publication
(10) Pub. No.: US 2026/0064160 A1
(43) Pub. Date: Mar. 5, 2026

(54) FOLDING ELECTRONIC DEVICE INCLUDING SUPPORT PLATE

(71) Applicant: SAMSUNG DISPLAY CO., LTD., YONGIN-SI (KR)

(72) Inventor: YONGKWON SOH, Yongin-si (KR)

(21) Appl. No.: 19/307,600

(22) Filed: Aug. 22, 2025

(30) Foreign Application Priority Data
Sep. 5, 2024 (KR) 10-2024-0120439

(51) Int. Cl. G06F 1/16

(52) U.S. Cl. CPC G06F 1/1656; G06F 1/1641

(57) ABSTRACT

An electronic device includes a display panel including a first non-folding region, a second non-folding region, and a folding region therebetween. A support plate is disposed below the display panel. A plurality of openings are defined in the support plate, overlapping the folding region. The support plate includes a first layer including a plurality of first fibers, and a second layer disposed above or below the first layer and including a plurality of second fibers. The first layer includes a first surface contacting the second layer and a second surface opposed to the first surface. A plurality of recess patterns are defined in the second surface.

### CROSS-REFERENCE TO RELATED APPLICATIONS

This U.S. non-provisional patent application claims priority under 35 U.S. C. § 119 to Korean Patent Application No. 10-2024-0120439, filed on Sep. 5, 2024, the entire contents of which are hereby incorporated by reference.

### TECHNICAL FIELD

The present disclosure herein relates to an electronic device and, more particularly, to a folding electronic device that includes a support plate.

### DISCUSSION OF THE RELATED ART

Electronic devices such as smartphones, digital cameras, laptop/notebook computers, navigation systems, and smart televisions typically include a display device that generates and presents images to a user through a display screen.

With advancements in display technology, new types of display devices are being developed that can bend, fold, or roll. Flexible electronic devices often feature a flexible display panel supported by a plate that is disposed below the display panel. This support plate may include a plurality of openings. However, when these openings are arranged in a lattice pattern, structural issues may occur in the support plate.

### SUMMARY

An electronic device includes a display panel including a first non-folding region, a second non-folding region, and a folding region disposed between the first non-folding region and the second non-folding region, and a support plate disposed below the display panel and including a plurality of openings overlapping the folding region. The support plate includes a first layer including a plurality of first fibers each extending in a first direction and arranged side by side with respect to each other in a second direction that is perpendicular to the first direction, and a second layer disposed either above or below the first layer and including a plurality of second fibers each extending in the second direction and arranged side by side with respect to each other in the first direction. The first layer includes a first surface contacting the second layer and a second surface opposed to the first surface. A plurality of recess patterns are defined in the second surface.

The plurality of recess patterns may overlap the folding region.

The plurality of recess patterns may be arranged side by side with respect to each other in the first direction.

The first layer may include a first portion adjacent to the second layer and a second portion that is spaced apart from the second layer with the first portion interposed therebetween in a cross-sectional view. Each of the plurality of recess patterns may penetrate the second portion and expose one surface of the first portion.

The plurality of openings may include a plurality of first openings defined in the first layer, and a plurality of second openings defined in the second layer and respectively corresponding to the plurality of first openings.

The plurality of recess patterns may respectively extend from the plurality of first openings in the second direction.

The support plate may include a first non-folding part overlapping the first non-folding region, a second non-folding part overlapping the second non-folding region, and a folding part overlapping the folding region.

The folding part may include a first region and a second region adjacent to the first region. The plurality of recess patterns may be defined in the first region, and the plurality of first openings may be defined in the second region.

An upper surface of the electronic device may include a display region in which an image is displayed, and a non-display region which surrounds the display region and overlaps an edge of the electronic device. The first region may overlap a portion of the non-display region.

An upper surface of the electronic device may include a display region in which an image is displayed, and a non-display region which surrounds the display region and overlaps an edge of the electronic device. The first region may overlap a portion of the display region.

The second layer may be disposed directly on the first layer, and the plurality of recess patterns may be defined in a first lower surface of the first layer.

The support plate may further include a lower layer disposed under the first layer and including a plurality of third fibers each extending in the second direction and arranged side by side with respect to each other in the first direction, and a plurality of lower holes respectively corresponding to the plurality of recess patterns may be defined in the lower layer.

The second layer may be disposed directly under the first layer, and the plurality of recess patterns may be defined in a first upper surface of the first layer.

The support plate may further include an upper layer disposed on the first layer and including a plurality of fourth fibers each extending in the second direction and arranged side by side with respect to each other in the first direction, and a plurality of upper holes respectively corresponding to the plurality of recess patterns may be defined in the upper layer.

The plurality of first fibers may include a plurality of (1-1)-th fibers and a plurality of (1-2)-th fibers disposed on the plurality of (1-1)-th fibers, and the plurality of (1-2)-th fibers may correspond to the plurality of (1-1)-th fibers.

The plurality of second fibers may include a plurality of (2-1)-th fibers and a plurality of (2-2)-th fibers disposed on the plurality of (2-1)-th fibers, and the plurality of (2-2)-th fibers may respectively correspond to the plurality of (2-1)-th fibers.

The electronic device may further include an upper adhesive layer disposed between the display panel and the support plate.

The electronic device may further include a cover layer overlapping the openings and disposed on a lower surface of the support plate.

The folding region may be configured to fold and unfolded about a folding axis.

The folding axis may extend in the second direction.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a perspective view of an electronic device according to an embodiment of the inventive concept;

FIGS. 2A and 2B are perspective views illustrating the electronic device illustrated in FIG. 1 in a folded state;

FIG. 3 is an exploded perspective view of the electronic device illustrated in FIG. 1;

FIG. 4 is a block diagram of an electronic device according to an embodiment of the inventive concept;

FIG. 5 is a cross-sectional view of a display module according to an embodiment of the inventive concept;

FIG. 6 is a cross-sectional view of a display panel according to an embodiment of the inventive concept;

FIG. 7 is a plan view of a display panel according to an embodiment of the inventive concept;

FIG. 8 is a cross-sectional view of an electronic panel according to an embodiment of the inventive concept;

FIGS. 9A and 9B are cross-sectional views of a display device according to an embodiment of the inventive concept;

FIG. 10 is a perspective view of a support plate according to an embodiment of the inventive concept;

FIG. 11 is an enlarged perspective view of a support plate according to an embodiment of the inventive concept;

FIG. 12 is a perspective view of a support plate according to an embodiment of the inventive concept;

FIGS. 13A to 13D are cross-sectional views of a support plate according to an embodiment of the inventive concept;

FIG. 14A is an enlarged perspective view of a support plate according to an embodiment of the inventive concept;

FIGS. 14B and 14C are cross-sectional views of a support plate according to an embodiment of the inventive concept;

FIG. 15A is an enlarged perspective view of a support plate according to an embodiment of the inventive concept; and

FIG. 15B is a cross-sectional view of a support plate according to an embodiment of the inventive concept.

### DETAILED DESCRIPTION

Aspects and features of the inventive concept, and a method of achieving the same will be clarified by referring to embodiments described below in detail with reference to the accompanying drawings. The inventive concept may, however, be embodied in different forms and should not necessarily be construed as limited to the embodiments set forth herein. Rather, these embodiments are provided so that this disclosure will be thorough and complete, and will fully convey the scope of the inventive concept to those skilled in the art. Like reference numerals or symbols may refer to like elements throughout the specification and the drawings.

An element or layer being referred to as being “on” another element or layer includes not only a case in which the element or layer is directly on the other element or layer but also a case in which an intervening element or layer is interposed therebetween. In contrast, an element or layer being referred to as being “directly on” another element or layer represents that there is no intervening element or layer interposed therebetween. As used herein, the term “and/or” includes any and all combinations of one or more of mentioned items.

Spatially relative terms, such as “below”, “beneath”, “lower”, “above”, “upper”, may be used herein to easily describe one element or feature's relationship to another element or feature as illustrated in the drawings. It will be understood that the spatially relative terms are intended to encompass different orientations of an element in use or operation in addition to an orientation illustrated in the drawings.

Although the terms first, second, etc. may be used herein to describe various elements, components, and/or sections, these elements, components, and/or sections are not necessarily limited by these terms. These terms are used to distinguish one element, component, or section from another element, component, or section. Thus, a first element, first component, or first section mentioned below may be a second element, second component, or second section without departing from the spirit of the inventive concept.

Embodiments described herein will be described with reference to a plan view and a cross-sectional view, which are ideal schematic views of the inventive concept. Accordingly, a shape of an illustrative drawing may be changed due to a manufacturing technique, tolerance, and/or the like. Thus, embodiments of the inventive concept are not necessarily limited to a particular form illustrated herein and include a form variation that may occur according to a manufacturing process. Therefore, regions illustrated in a drawing as examples have schematic properties, and shapes of the regions illustrated in the drawing as examples are intended to provide examples of particular forms of a region of an element and are not necessarily intended to limit the scope of the inventive concept.

Exemplary embodiments of the present disclosure relate to various approaches for enhancing the structure of a foldable electronic device, such as, for example, by implementing a special support plate beneath the display panel. Traditionally, a “bridge” structure may be used between non-folding regions across the folding axis to provide mechanical support. However, this design may introduce issues like burr formation during processing, which can hinder both device integrity and foldability.

Embodiments of the present disclosure may replace that bridge with a novel fiber-reinforced composite structure, particularly a carbon fiber reinforced plastic (CFRP), in which fibers are arranged in a crossed and laminated fashion. Instead of incorporating a full opening or hole, a half-cut or recess is applied selectively to either the top or bottom layer of the support plate in the folding region. These recesses are aligned with the folding axis and are positioned in areas where fiber directions are orthogonally arranged.

This approach may allow the support plate to maintain its structural support while increasing flexibility along the folding axis. Because no through-holes are made in this revised configuration, the formation of burrs that would otherwise result from cutting through the full material thickness may be avoided. Thus, foldability of the device may be preserved while streamlining the manufacturing process and increasing device durability.

Hereinafter, an embodiment of the inventive concept will be described in more detail with reference to the accompanying drawings.

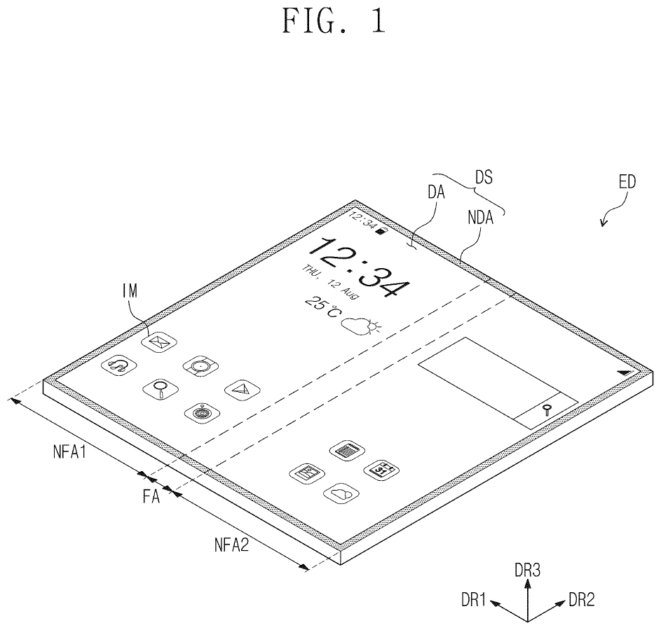

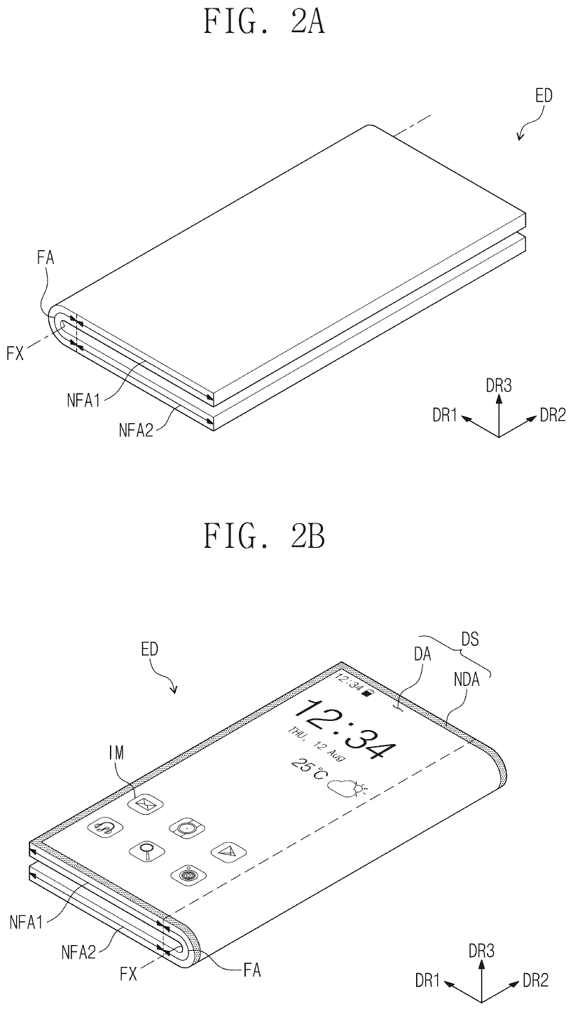

FIG. 1 is a perspective view of an electronic device according to an embodiment of the inventive concept. FIGS. 2A and 2B are diagrams illustrating the electronic device illustrated in FIG. 1 in a folded state.

Referring to FIG. 1, an electronic device ED, according to an embodiment of the inventive concept, may have a substantially rectangular shape having a pair of short sides extending in a first direction DR1 and a pair of long sides extending in a second direction DR2 crossing the first direction DR1. However, an embodiment of the inventive concept is not necessarily limited thereto, and the electronic device ED may have various shapes such as a circular shape and a polygonal shape. The electronic device ED may be flexible and may be able to be bent to at least a noticeable extent without cracking or otherwise sustaining damage.

Hereinafter, a direction substantially perpendicularly crossing a plane that is defined by the first direction DR1 and the second direction DR2 will be defined as a third direction DR3. In addition, as used herein, the wording “in a plan view” may be defined as a state of being viewed from the third direction DR3.

The electronic device ED may include a folding region FA and a plurality of non-folding regions NFA1 and NFA2. The non-folding regions NFA1 and NFA2 may include a first non-folding region NFA1 and a second non-folding region NFA2. The folding region FA may be disposed between the first non-folding region NFA1 and the second non-folding region NFA2. The folding region FA, the first non-folding region NFA1, and the second non-folding region NFA2 may be arranged in the first direction DR1 and may together from a single continuous surface.

One folding region FA and two non-folding regions NFA1 and NFA2 are illustrated as an example, but the number of the folding region FA and the number of the non-folding regions NFA1 and NFA2 are not necessarily limited thereto. For example, the electronic device ED may include more than two non-folding regions and a plurality of folding regions, each of which is disposed between a proximate pair of the non-folding regions.

An upper surface of the electronic device ED may be a display surface DS, and the display surface DS may have a plane that is defined by the first direction DR1 and the second direction DR2. Images IM that are generated in the electronic device ED may be provided to a user through the display surface DS.

The display surface DS may include a display region DA and a non-display region NDA around (for example, proximate to or surrounding) the display region DA. An image may be displayed in the display region DA, and an image might not be displayed in the non-display region NDA. The non-display region NDA may surround the display region DA and may define an edge of the electronic device ED printed in a predetermined color.

Referring to FIGS. 2A and 2B, the electronic device ED may be a foldable electronic device ED that is configured to be folded and unfolded. For example, the folding region FA may be bent with respect to a folding axis FX parallel to the second direction DR2, so that the electronic device ED may be folded. The folding axis FX may be a long axis that is parallel to a long side of the electronic device ED. When the electronic device ED is folded, the electronic device ED may be in-folded such that the first non-folding region NFA1 and the second non-folding region NFA2 face each other and the display surface DS is protected and not exposed to the outside. However, an embodiment of the inventive concept is not necessarily limited thereto. For example, as illustrated in FIG. 2B, the electronic device ED may be out-folded with respect to the folding axis FX such that the display surface DS is exposed to the outside and remains visible when folded. In addition, the electronic device ED may be in-folded and out-folded at the same time.

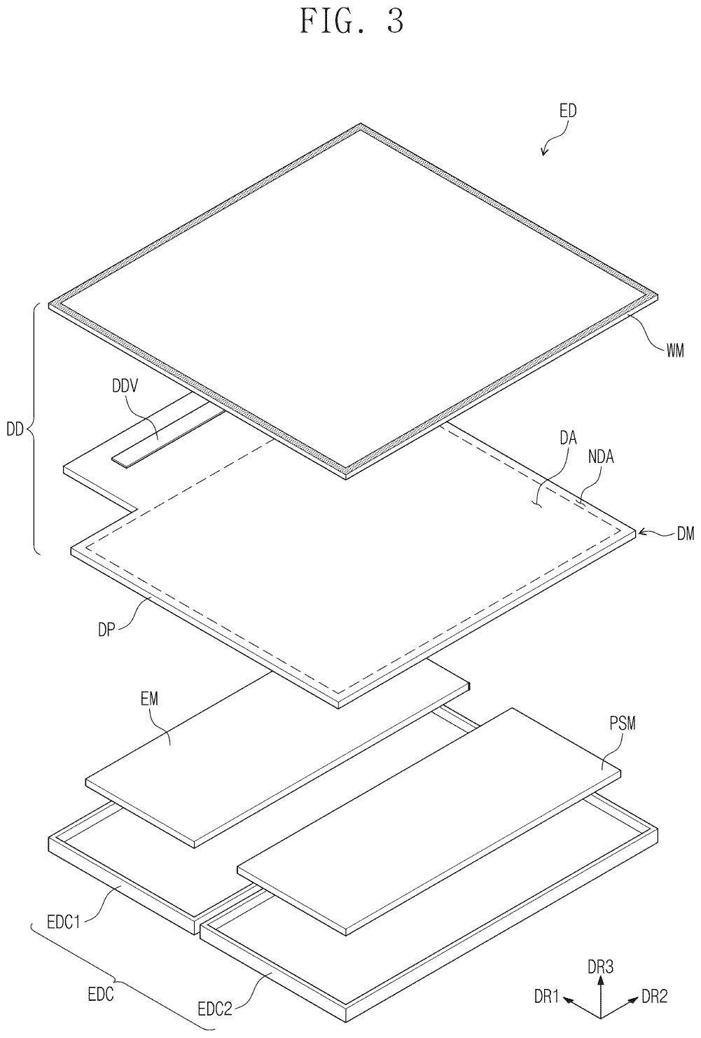

FIG. 3 is an exploded perspective view of the electronic device illustrated in FIG. 1.

Referring to FIG. 3, the electronic device ED may include a display device DD, an electronic module EM, a power module PSM, and a case EDC. The electronic device ED may further include a mechanical structure (for example, a hinge) for controlling a folding operation of the display device DD.

The display device DD may generate an image and sense an external input. The display device DD may include a window module WM and a display module DM. The window module WM may provide a front surface of the electronic device ED. The window module WM may be disposed on the display module DM and may protect the display module DM. The window module WM may transmit light that is generated in the display module DM and provide the light to a user therethrough.

The display module DM may include a display panel DP. While FIG. 3 illustrates only the display panel DP of a stacked structure of the display module DM, the display module DM may further include a plurality of components disposed above and below the display panel DP. A detailed stacked structure of the display module DM will be described in detail below. The display panel DP may include a display region DA and a non-display region NDA corresponding to the display region DA and the non-display region NDA of FIG. 1 of the electronic device ED.

The display module DM may include a data driver DDV disposed in the non-display region NDA of the display panel DP. The data driver DDV may be manufactured in a form of an integrated circuit chip and mounted in the non-display region NDA. However, an embodiment of the inventive concept is not necessarily limited thereto, and the data driver DDV may be mounted on a flexible circuit board connected to the display panel DP.

The electronic module EM and the power module PSM may be disposed under the display device DD. The electronic module EM and the power module PSM may be connected to each other through a separate flexible circuit board. The electronic module EM may control an operation of the display device DD. The power module PSM may supply power to the electronic module EM.

The case EDC may accommodate the display device DD, the electronic module EM, and the power module PSM. The case EDC may include first and second cases EDC1 and EDC2 as two cases to fold the display device DD. The first and second cases EDC1 and EDC2 may extend in the second direction DR2 and may be arranged in the first direction DR1.

The electronic device ED may further include a hinge structure for connecting the first and second cases EDC1 and EDC2. The case EDC may be coupled to the window module WM. The case EDC may protect the display device DD, the electronic module EM, and the power module PSM.

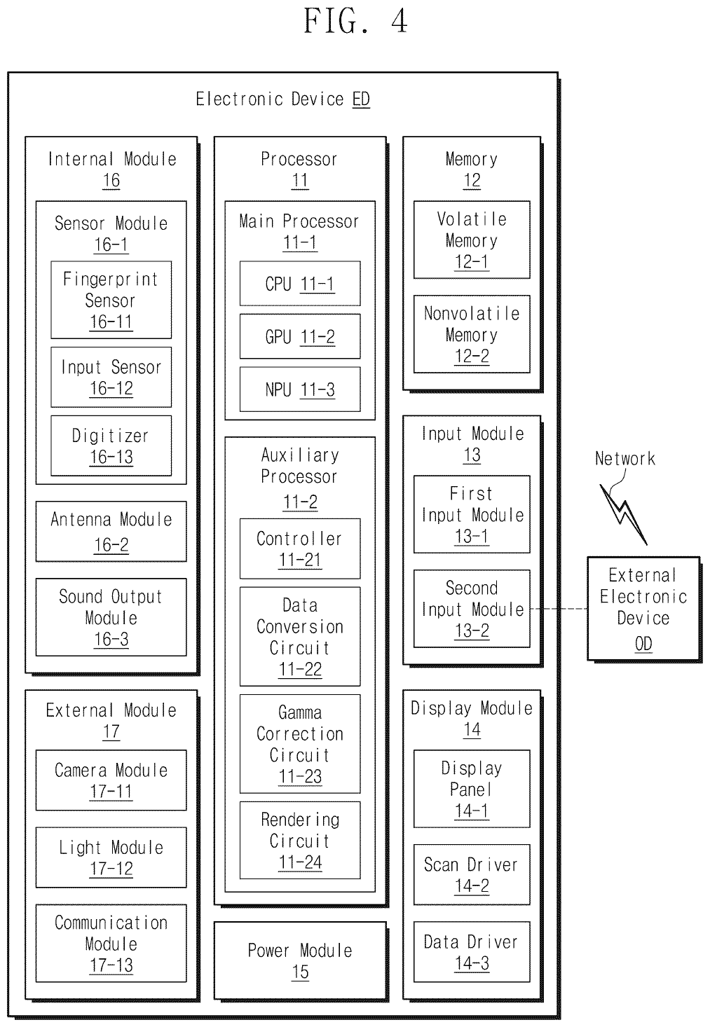

FIG. 4 is a block diagram of an electronic device according to an embodiment of the inventive concept.

Referring to FIG. 4, an electronic device ED outputs various information through a display module 14 in an operating system. When a processor 11 executes an application stored in a memory 12, the display module 14 provides application information to a user through a display panel 14-1. The display module 14 of FIGS. 2A and 2B may refer to the display module DM described above, and the display panel 14-1 may refer to the display panel DP described above.

The processor 11 obtains an external input through an input module 13 or a sensor module 16-1 and executes an application corresponding to the external input. For example, when a user selects a camera icon displayed on the display panel 14-1, the processor 11 obtains a user's input through an input sensor 16-12 and activates a camera module 17-11. The processor 11 transmits, to the display module 14, image data corresponding to a captured image that is obtained through the camera module 17-11. The display module 14 may display an image corresponding to the captured image through the display panel 14-1.

For example, when personal information authentication is executed in the display module 14, a fingerprint sensor 16-11 obtains input fingerprint information as input data. The processor 11 compares the input data obtained through the fingerprint sensor 16-11 with authentication data stored in the memory 12 and executes an application according to a comparison result. The display module 14 may display information that is executed according to a logic of the application through the display panel 14-1.

For example, when a music streaming icon displayed through the display module 14 is selected, the processor 11 obtains a user input through the input sensor 16-12 and activates a music streaming application stored in the memory 12. When a music execution command is input in the music streaming application, the processor 11 activates a sound output module 16-3 (for example, including a speaker) and provides sound information corresponding to the music execution command to a user.

An operation of the electronic device ED is briefly described above. Hereinafter, a configuration of the electronic device ED will be described in detail. Some of components of the electronic device ED to be described later may be integrated and provided as one component, and one component may be separated and provided as two or more components.

Referring to FIGS. 2A and 2B, the electronic device ED may communicate with an external electronic device OD through a network (for example, short-range wireless communication network or long-range wireless communication network). According to an embodiment, the electronic device ED may include the processor 11, the memory 12, the input module 13, the display module 14, a power module 15, an internal module 16, and an external module 17. According to an embodiment, in the electronic device ED, at least one of the components described above may be omitted, or one or more other components may be added. According to an embodiment, some (for example, the sensor module 16-1, an antenna module 16-2, or the sound output module 16-3) of the components described above may be integrated to another component (for example, the display module 14).

The processor 11 may execute software to control at least one other component (for example, hardware or software component) of the electronic device ED connected to the processor 11 and perform various data processing or operations. According to an embodiment, as at least part of the data processing or operations, the processor 11 may store data or a command received from another component (for example, the input module 13, the sensor module 16-1, or a communication module 17-13) in a volatile memory 12-1 and process the data or command stored in the volatile memory 12-1, and result data may be stored in a nonvolatile memory 12-2.

The processor 11 may include a main processor 11-1 and an auxiliary processor 11-2. The main processor 11-1 may include a central processing unit (CPU) 11-11 and/or an application processor (AP). The main processor 11-1 may further include a graphic processing unit (GPU) 11-12, a communication processor (CP), and/or an image signal processor (ISP). The main processor 11-1 may further include a neural processing unit (NPU) 11-13. A neural processing unit is a processor that is specialized for processing an artificial intelligence model, and the artificial intelligence model may be generated through one or more suitable machine learning techniques. The artificial intelligence model may include a plurality of artificial neural network layers. An artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, and a combination of two or more thereof, but is not necessarily limited to the examples described above. The artificial intelligence model may include software structure in addition to or instead of hardware structure. At least two among the processing units and processors described above may be implemented as one integrated component (for example, a single chip) or may be each implemented as an independent component (for example, a plurality of chips).

The auxiliary processor 11-2 may include a controller 11-21. The controller 11-21 may include an interface conversion circuit and a timing control circuit. The controller 11-21 receives an image signal from the main processor 11-1, converts data format of the image signal to comply with specifications of interface with the display module 14, and outputs image data. The controller 11-21 may output various control signals required for driving the display module 14.

The auxiliary processor 11-2 may further include a data conversion circuit 11-22, a gamma correction circuit 11-23, a rendering circuit 11-24, etc. The data conversion circuit 11-22 may receive image data from the controller 11-21, and may compensate for the image data such that an image is displayed at a desired luminance according to characteristics of the electronic device ED, a user's setting, or the like, or may convert the image data to reduce power consumption, to compensate for an afterimage, or the like. The gamma correction circuit 11-23 may convert image data, a gamma reference voltage, or the like such that an image displayed on the electronic device ED has a desired gamma characteristic. The rendering circuit 11-24 may receive image data from the controller 11-21 and render the image data in consideration of pixel arrangement of the display panel 14-1 applied to the electronic device ED, etc. At least one of the data conversion circuit 11-22, the gamma correction circuit 11-23, or the rendering circuit 11-24 may be integrated to another component (for example, the main processor 11-1 or the controller 11-21). At least one of the data conversion circuit 11-22, the gamma correction circuit 11-23, or the rendering circuit 11-24 may be integrated to a data driver 14-3 to be described later.

The memory 12 may store various pieces of data that are used by at least one component (for example, the processor 11 or the sensor module 16-1) of the electronic device ED, and output data or input data about a command related thereto. The memory 12 may include the volatile memory 12-1 and/or the nonvolatile memory 12-2.

The input module 13 may receive data or a command to be used for a component (for example, the processor 11, the sensor module 16-1, or the sound output module 16-3) of the electronic device ED from the outside (for example, a user or the external electronic device OD) of the electronic device ED.

The input module 13 may include a first input module 13-1 to which a command or data is input from a user and a second input module 13-2 to which a command or data is input from the external electronic device OD. The first input module 13-1 may include a microphone, a mouse, a keyboard, a key (for example, a button), or a pen/stylus (for example, a passive pen/stylus or an active pen/stylus). The second input module 13-2 may support a designated protocol for connection to the external electronic device OD wirelessly or by wire. According to an embodiment, the second input module 13-2 may include a high definition multimedia interface (HDMI), a universal serial bus (USB) interface, a Secure Digital (SD) card interface, or an audio interface. The second input module 13-2 may include a connector, for example, an HDMI connector, a USB connector, an SD card connector, or an audio connector (for example, a headphone connector), for physical connection to the external electronic device OD.

The display module 14 visually provides information to a user. The display module 14 may include the display panel 14-1, a scan driver 14-2, and the data driver 14-3. The display module 14 may further include a chassis and a bracket for protecting the display panel 14-1.

The display panel 14-1 may include a liquid crystal display panel, an organic light-emitting display panel, or an inorganic light-emitting display panel, and a type of the display panel 14-1 is not particularly limited to the examples provided herein. The display panel 14-1 may be a rigid-type or flexible-type panel capable of being rolled or folded to at least a noticeable extent without cracking or otherwise sustaining damage. The display module 14 may further include a supporter that supports the display panel 14-1, a bracket, a heat dissipation structure, or the like. The display panel 14-1 will be described in detail below with reference to FIG. 3 and subsequent drawings.

The scan driver 14-2 may be mounted on the display panel 14-1 as a driving chip. In addition, the scan driver 14-2 may be integrated to the display panel 14-1. For example, the scan driver 14-2 may include an amorphous silicon TFT gate driver circuit (ASG), a low temperature polycrystalline silicon (LTPS) TFT gate driver circuit, or an oxide semiconductor TFT gate driver circuit (OSG) built in the display panel 14-1. The scan driver 14-2 receives a control signal from the controller 11-21 and outputs scan signals to the display panel 14-1 in response to the control signal.

The display panel 14-1 may further include a light emission driver. The light emission driver outputs a light emission control signal to the display panel 14-1 in response to a control signal received from the controller 11-21. The light emission driver may be formed separately from the scan driver 14-2 or may be integrated to the scan driver 14-2.

The data driver 14-3 receives a control signal from the controller 11-21, converts image data into an analog voltage (for example, a data voltage) in response to the control signal, and then outputs data voltages to the display panel 14-1.

The data driver 14-3 may be integrated to another component (for example, the controller 11-21). Functions of the interface conversion circuit and the timing control circuit of the controller 11-21 described above may be integrated to the data driver 14-3.

The display module 14 may further include a light emission driver, a voltage generation circuit, and the like. The voltage generation circuit may output various voltages required for driving the display panel 14-1.

The power module 15 supplies power to a component of the electronic device ED. The power module 15 may include a battery that charges a power voltage. The battery may include a non-rechargeable primary cell, a rechargeable secondary cell, or a fuel cell. The power module 15 may include a power management integrated circuit (PMIC). The PMIC supplies optimized power to each of the module described above and a module to be described later. The power module 15 may include a wireless power transmission/reception element electrically connected to the battery. The wireless power transmission/reception element may include a plurality of antenna radiators in a coil form.

The electronic device ED may further include the internal module 16 and the external module 17. The internal module 16 may include the sensor module 16-1, the antenna module 16-2, and the sound output module 16-3. The external module 17 may include the camera module 17-11, a light module 17-12, and the communication module 17-13.

The sensor module 16-1 may sense an input from a user's body or an input from a pen/stylus of the first input module 13-1 and generate a data value or an electrical signal corresponding to the input. The sensor module 16-1 may include the fingerprint sensor 16-11, the input sensor 16-12, and/or a digitizer 16-13.

The fingerprint sensor 16-11 may generate a data value corresponding to a user's fingerprint. The fingerprint sensor 16-11 may include any one of an optical fingerprint sensor and a capacitive fingerprint sensor.

The input sensor 16-12 may generate a data value corresponding to coordinate information about an input from a user's body or an input from a pen/stylus. The input sensor 16-12 generates the amount of a change in capacitance due to an input as a data value. The input sensor 16-12 may sense an input from a passive pen/stylus or transmit/receive data to/from an active pen/stylus.

The input sensor 16-12 may measure a biosignal such as blood pressure, water, or body fat. For example, when a user is in contact with a sensor layer or a sensing panel with a part of the user's body and does not move for a certain amount of time, the input sensor 16-12 may sense a biosignal on the basis of a change in electric field due to the part of the user's body and output information desired by the user to the display module 14.

The digitizer 16-13 may generate a data value corresponding to coordinate information about an input from a pen/stylus. The digitizer 16-13 generates the amount of an electromagnetic change due to an input as a data value. The digitizer 16-13 may sense an input from a passive pen/stylus or transmit/receive data to/from an active pen/stylus.

At least one of the fingerprint sensor 16-11, the input sensor 16-12, or the digitizer 16-13 may be implemented as an input sensing layer ISL (see FIG. 3) that is formed on the display panel 14-1 through single a continuous process. The fingerprint sensor 16-11, the input sensor 16-12, and the digitizer 16-13 may be disposed above the display panel 14-1, and any one of the fingerprint sensor 16-11, the input sensor 16-12, and the digitizer 16-13, for example, the digitizer 16-13 may be disposed below the display panel 14-1.

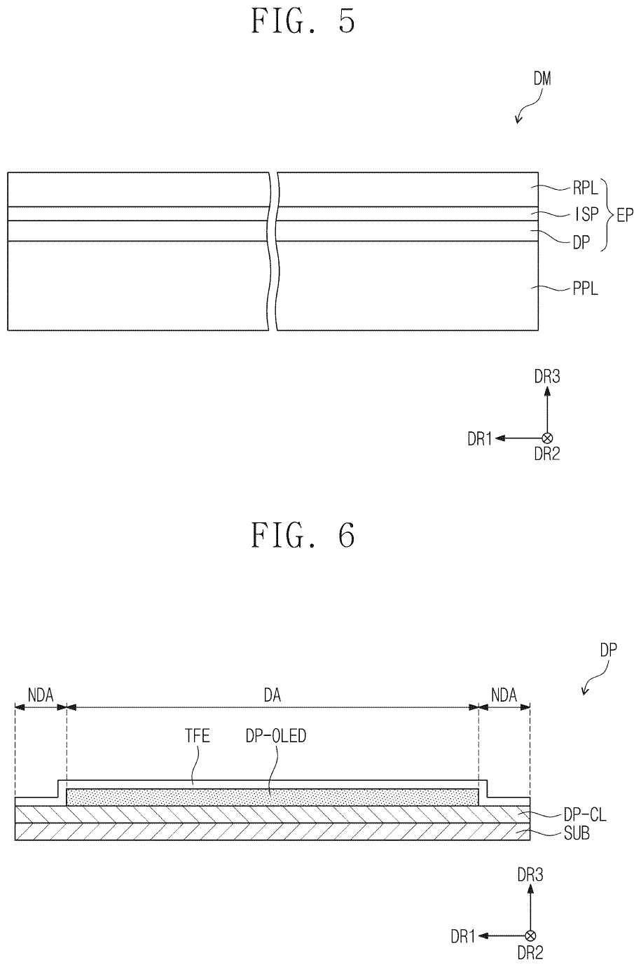

At least two of the fingerprint sensor 16-11, the input sensor 16-12, and the digitizer 16-13 may be formed to be integrated as one sensing panel through the same process. In a case in which the at least two thereof are integrated to one sensing panel, the sensing panel may be disposed between the display panel 14-1 and the window module WM (see FIG. 3) disposed above the display panel 14-1. According to an embodiment, the sensing panel may be disposed on the window module WM (see FIG. 3), and a position of the sensing panel is not particularly limited to the examples provided herein. FIG. 5 to be described later illustrates an input sensing part ISP disposed between the display panel 14-1 and the window module WM (see FIG. 3) disposed above the display panel 14-1, but an embodiment is not necessarily limited thereto.

At least one of the fingerprint sensor 16-11, the input sensor 16-12, or the digitizer 16-13 may be built in the display panel 14-1. That is, at least one of the fingerprint sensor 16-11, the input sensor 16-12, or the digitizer 16-13 may be simultaneously formed through a process of forming elements (for example, a light-emitting element, a transistor, etc.) included in the display panel 14-1.

In addition, the sensor module 16-1 may generate a data value or an electrical signal corresponding to an internal state or an external state of the electronic device ED. The sensor module 16-1 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 16-2 may include one or more antennas for transmitting or receiving a signal or power to or from the outside. According to an embodiment, the communication module 17-13 may transmit or receive a signal to or from an external electronic device through an antenna suitable for a communication method. An antenna pattern of the antenna module 16-2 may be integrated to one component (for example, the display panel 14-1) of the display module 14, the input sensor 16-12, or the like.

The sound output module 16-3 may be a device for outputting a sound signal to the outside of the electronic device ED and include, for example, a speaker that is used for general purposes such as playing multimedia or playing a recording and a receiver that is used only for receiving a call. According to an embodiment, the receiver may be formed integrally with or separately from the speaker. A sound output pattern of the sound output module 16-3 may be integrated to the display module 14.

The camera module 17-11 may capture a still image and a moving image. According to an embodiment, the camera module 17-11 may include one or more lenses, an image sensor, or an image signal processor. The camera module 17-11 may further include an infrared camera capable of measuring presence/absence of a user, a position of a user, a gaze of a user, etc.

The light module 17-12 may provide light. The light module 17-12 may include a light-emitting diode or a xenon lamp. The light module 17-12 may operate in association with the camera module 17-11 or may operate independently.

The communication module 17-13 may support establishing a wired or wireless communication channel between the electronic device ED and the external electronic device OD and performing communication via the established communication channel. The communication module 17-13 may include any one of or both of a wireless communication module such as a cellular communication module, a short-range wireless communication module, or a global navigation satellite system (GNSS) communication module and a wired communication module such as a local area network (LAN) communication module or a power line communication module. The communication module 17-13 may communicate with the external electronic device OD via a short-range communication network such as Bluetooth, Wi-Fi direct, or infrared data association (IrDA) or a long-range communication network such as a cellular network, internet, or a computer network (for example, LAN or WAN). The various types of the communication module 17-13 described above may be implemented as one chip or may be implemented as separate chips.

The input module 13, the sensor module 16-1, the camera module 17-11, etc., may be used to control an operation of the display module 14 in association with the processor 11.

The processor 11 outputs a command or data to the display module 14, the sound output module 16-3, the camera module 17-11, or the light module 17-12 on the basis of input data received from the input module 13. For example, the processor 11 may generate image data in correspondence to input data applied through a mouse, an active pen/stylus, or the like and output the image data to the display module 14, or may generate command data in correspondence to input data and output the command data to the camera module 17-11 or the light module 17-12. When input data is not received from the input module 13 for a certain amount of time, the processor 11 may change an operation mode of the electronic device ED to a low power mode or a sleep mode, thereby reducing power consumption of the electronic device ED.

The processor 11 outputs a command or data to the display module 14, the sound output module 16-3, the camera module 17-11, or the light module 17-12 on the basis of sensing data received from the sensor module 16-1. For example, the processor 11 may compare authentication data applied by the fingerprint sensor 16-11 with authentication data stored in the memory 12, and then may execute an application according to a comparison result. The processor 11 may execute a command or output corresponding image data to the display module 14 on the basis of sensing data sensed by the input sensor 16-12 or the digitizer 16-13. In a case in which a temperature sensor is included in the sensor module 16-1, the processor 11 may receive temperature data about a measured temperature from the sensor module 16-1 and further perform luminance correction on image data, etc., on the basis of the temperature data.

The processor 11 may receive measurement data about presence/absence of a user, a position of a user, a gaze of a user, etc., from the camera module 17-11. The processor 11 may further perform luminance correction on image data, etc., on the basis of the measurement data. For example, the processor 11 determines presence/absence of a user through an input from the camera module 17-11, and then the processor 11 may output image data of which luminance is corrected through the data conversion circuit 11-22 or the gamma correction circuit 11-23 to the display module 14.

Some of the above components may be connected to each other via a communication method between peripheral devices, for example, bus, general purpose input/output (GPIO), serial peripheral interface (SPI), mobile industry processor interface (MIPI), or ultra path interconnect (UPI) link, and may exchange a signal (for example, a command or data). The processor 11 may communicate with the display module 14 via a mutually agreed interface, and for example, may use one of the communication methods described above, and a communication method is not necessarily limited thereto.

FIG. 5 is a cross-sectional view of a display module according to an embodiment of the inventive concept.

Referring to FIG. 5, a display module DM may include a display panel DP, an input sensing part ISP disposed on the display panel DP, an anti-reflective layer RPL disposed on the input sensing part ISP, and a panel protective layer PPL disposed under the display panel DP. The display panel DP may be a flexible display panel. For example, the display panel DP may include a flexible substrate and a plurality of elements disposed on the flexible substrate.

The display panel DP, according to an embodiment of the inventive concept, may be an emissive display panel and is not particularly limited to the examples provided herein. For example, the display panel DP may be an organic light-emitting diode (OLED) display panel or an inorganic light-emitting display panel. An emission layer of the OLED display panel may include an organic light-emitting material. An emission layer of the inorganic light-emitting display panel may include quantum dots, quantum rods, and the like. Hereinafter, the display panel DP will be described as an OLED display panel.

The input sensing part ISP may include a plurality of sensor parts for sensing an external input by using a capacitive method. The input sensing part ISP may be directly formed on the display panel DP when the display module DM is manufactured.

The anti-reflective layer RPL may be disposed on the input sensing part ISP. The anti-reflective layer RPL may be directly formed on the input sensing part ISP when the display module DM is manufactured. The anti-reflective layer RPL may be an external light anti-reflection film. The anti-reflective layer RPL may reduce reflectance for external light incident to the display panel DP from above the display module DM.

By way of example, the input sensing part ISP may be directly formed on the display panel DP, and the anti-reflective layer RPL may be directly formed on the input sensing part ISP, but an embodiment of the inventive concept is not necessarily limited thereto. For example, the input sensing part ISP may be separately manufactured and attached to the display panel DP through an adhesive layer, and the anti-reflective layer RPL may be separately manufactured and attached to the input sensing part ISP through an adhesive layer.

The display panel DP, the input sensing part ISP, and the anti-reflective layer RPL may be an electronic panel EP.

The panel protective layer PPL may be disposed under the display panel DP. The panel protective layer PPL may protect a lower portion of the display panel DP. The panel protective layer PPL may include a flexible plastic material. For example, the panel protective layer PPL may include polyethylene terephthalate.

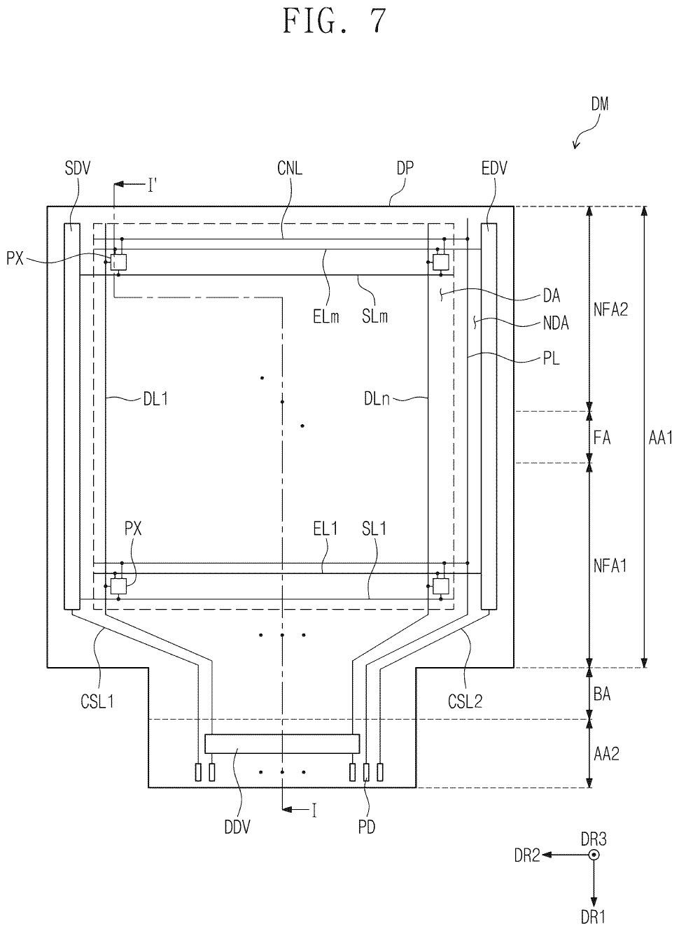

FIG. 6 is a cross-sectional view of a display panel according to an embodiment of the inventive concept. FIG. 6 illustrates a cross section of a display panel DP viewed from the second direction DR2 as an example.

Referring to FIG. 6, the display panel DP may include a substrate SUB, a circuit element layer DP-CL disposed on the substrate SUB, a display element layer DP-OLED disposed on the circuit element layer DP-CL, and a thin-film encapsulation layer TFE disposed on the display element layer DP-OLED.

The substrate SUB may include a display region DA and a non-display region NDA around the display region DA. The substrate SUB may include glass or a flexible plastic material such as polyimide. The display element layer DP-OLED may be disposed on the display region DA.

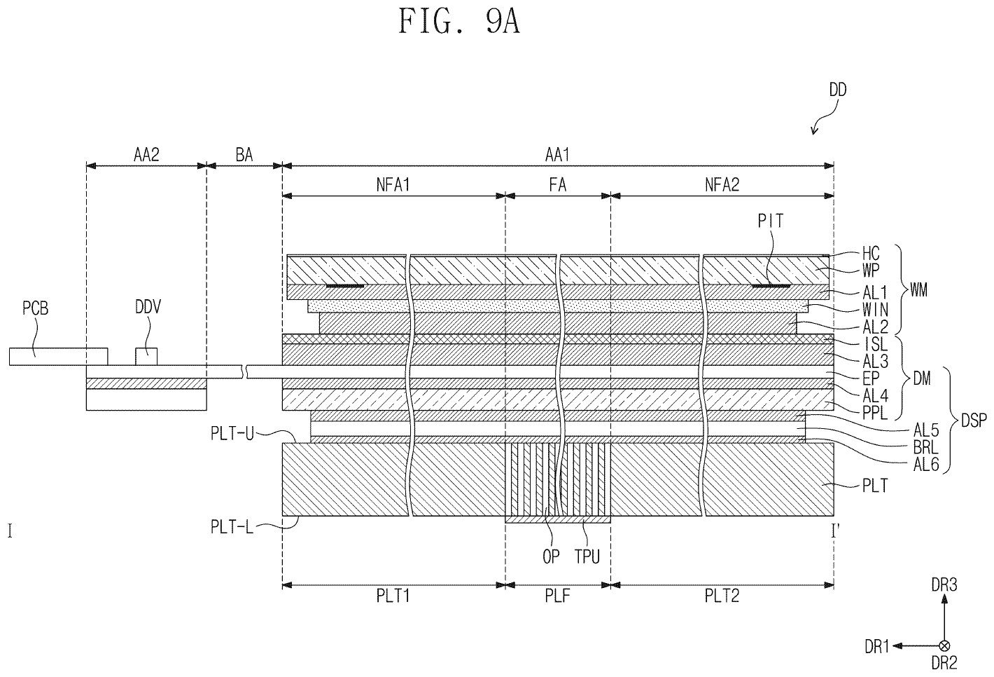

A plurality of pixels may be disposed in the circuit element layer DP-CL and the display element layer DP-OLED. Each of the pixels may include a transistor disposed in the circuit element layer DP-CL and a light-emitting element disposed in the display element layer DP-OLED and connected to the transistor. A configuration of a pixel will be described in detail with reference to FIG. 8.

The thin-film encapsulation layer TFE may be disposed on the circuit element layer DP-CL and may cover the display element layer DP-OLED. The thin-film encapsulation layer TFE may protect the pixels from moisture, oxygen, and foreign substances of the outside.

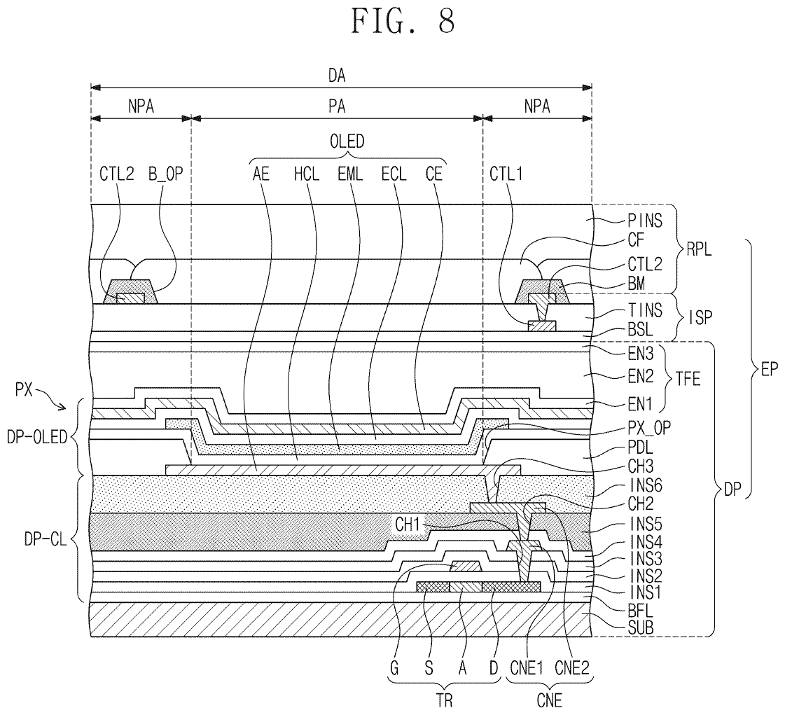

FIG. 7 is a plan view of a display panel according to an embodiment of the inventive concept.

Referring to FIG. 7, a display module DM may include a display panel DP, a scan driver SDV, a data driver DDV, and a light emission driver EDV.

The display panel DP may include a first non-bending region AA1, a second non-bending region AA2, and a bending region BA disposed between the first non-bending region AA1 and the second non-bending region AA2. The bending region BA may extend in the second direction DR2, and the first non-bending region AA1, the bending region BA, and the second non-bending region AA2 may be arranged in the first direction DR1.

The first non-bending region AA1 may include a display region DA and a non-display region NDA around the display region DA. The non-display region NDA may surround the display region DA. The display region DA may be a region in which an image is displayed, and the non-display region NDA may be a region in which an image is not displayed. The second non-bending region AA2 and the bending region BA may be a region in which an image is not displayed.

When viewed from the second direction DR2, the first non-bending region AA1 may include a first non-folding region NFA1, a second non-folding region NFA2, and a folding region FA between the first non-folding region NFA1 and the second non-folding region NFA2.

The display panel DP may include a plurality of pixels PX, a plurality of scan lines SL1 to SLm, a plurality of data lines DL1 to DLn, a plurality of light emission lines EL1 to ELm, first and second control lines CSL1 and CSL2, a power line PL, a plurality of connection lines CNL, and a plurality of pads PD. As used herein, “m” and “n” are positive integers. The pixels PX may be disposed in the display region DA and may be connected to the scan lines SL1 to SLm, the data lines DL1 to DLn, and the light emission lines EL1 to ELm.

The scan driver SDV and the light emission driver EDV may be disposed in the non-display region NDA. The scan driver SDV and the light emission driver EDV may be disposed in sections of the non-display region NDA respectively adjacent to two sides of the first non-bending region AA1 opposed to each other in the second direction DR2. The data driver DDV may be disposed in the second non-bending region AA2. The data driver DDV may be manufactured in a form of an integrated circuit chip and mounted on the second non-bending region AA2.

The scan lines SL1 to SLm may extend in the second direction DR2 and may be connected to the scan driver SDV. The data lines DL1 to DLn may extend in the first direction DR1 and may be connected to the data driver DDV via the bending region BA. The light emission lines EL1 to ELm may extend in the second direction DR2 to be connected to the light emission driver EDV.

The power line PL may extend in the first direction DR1 to be disposed in the non-display region NDA. The power line PL may be disposed between the display region DA and the light emission driver EDV, but an embodiment of the inventive concept is not necessarily limited thereto, and the power line PL may be disposed between the display region DA and the scan driver SDV.

The power line PL may extend to the second non-bending region AA2 via the bending region BA. The power line PL may extend toward a lower end of the second non-bending region AA2 in a plan view. The power line PL may receive a driving voltage.

The connection lines CNL may extend in the second direction DR2 and may be arranged in the first direction DR1. The connection lines CNL may be connected to the power line PL and the pixels PX. A driving voltage may be applied to the pixels PX through the connection lines CNL and the power line PL connected to each other.

The first control line CSL1 may be connected to the scan driver SDV and extend toward the lower end of the second non-bending region AA2 via the bending region BA. The second control line CSL2 may be connected to the light emission driver EDV and extend toward the lower end of the second non-bending region AA2 via the bending region BA. The data driver DDV may be disposed between the first control line CSL1 and the second control line CSL2.

In a plan view, the pads PD may be adjacent to the lower end of the second non-bending region AA2. The data driver DDV, the power line PL, the first control line CSL1, and the second control line CSL2 may be connected to the pads PD.

The data lines DL1 to DLn may be connected to corresponding pads PD through the data driver DDV. For example, the data lines DL1 to DLn may be connected to the data driver DDV, and the data driver DDV may be connected to the pads PD respectively corresponding to the data lines DL1 to DLn.

A printed circuit board may be connected to the pads PD, and a timing controller and a voltage generator may be disposed on the printed circuit board. The timing controller may be manufactured as an integrated circuit chip and mounted on the printed circuit board. The timing controller and the voltage generator may be connected to the pads PD through the printed circuit board.

The timing controller may control an operation of the scan driver SDV, the data driver DDV, and the light emission driver EDV. The timing controller may generate a scan control signal, a data control signal, and a light emission control signal in response to control signals received from the outside. The voltage generator may generate a driving voltage.

The scan control signal may be provided to the scan driver SDV through the first control line CSL1. The light emission control signal may be provided to the light emission driver EDV through the second control line CSL2. The data control signal may be provided to the data driver DDV. The timing controller may receive image signals from the outside, convert data format of the image signals to comply with specifications of interface with the data driver DDV, and provide the image signals with converted data format to the data driver DDV.

The scan driver SDV may generate a plurality of scan signals in response to the scan control signal. The scan signals may be applied to the pixels PX through the scan lines SL1 to SLm. The scan signals may be sequentially applied to the pixels PX.

The data driver DDV may generate a plurality of data voltages corresponding to image signals in response to the data control signal. The data voltages may be applied to the pixels PX through the data lines DL1 to DLn. The light emission driver EDV may generate a plurality of light emission signals in response to the light emission control signal. The light emission signals may be applied to the pixels PX through the light emission lines EL1 to ELm.

The pixels PX may be provided with the data voltages in response to the scan signals. The pixels PX may display an image by emitting light having luminance corresponding to the data voltages in response to the light emission signals. Light emission time of the pixels PX may be controlled by the light emission signals.

FIG. 8 is a cross-sectional view of an electronic panel according to an embodiment of the inventive concept. FIG. 8 illustrates a cross section of an electronic panel EP corresponding to one pixel illustrated in FIG. 7 as an example.

Referring to FIG. 8, a pixel PX may include a transistor TR and a light-emitting element OLED. The light-emitting element OLED may include a first electrode AE (or anode), a second electrode CE (or cathode), a hole control layer HCL, an electron control layer ECL, and an emission layer EML.

The transistor TR and the light-emitting element OLED may be disposed on a substrate SUB. One transistor TR is illustrated as an example, but substantially, the pixel PX may include at least one capacitor and a plurality of transistors for driving the light-emitting element OLED.

A display region DA may include a light-emitting region PA corresponding to each of the pixels PX and a non-light-emitting region NPA around the light-emitting region PA. The light-emitting element OLED may be disposed in the light-emitting region PA.

A buffer layer BFL may be disposed on the substrate SUB, and the buffer layer BFL may be an inorganic layer. A semiconductor pattern may be disposed on the buffer layer BFL. The semiconductor pattern may include polysilicon, amorphous silicon, or metal oxide.

The semiconductor pattern may be doped with an N-type dopant or a P-type dopant. The semiconductor pattern may include a heavily doped region and a lightly doped region. The heavily doped region may have a higher conductivity than the lightly doped region and substantially serve as a source electrode and a drain electrode of the transistor TR. The lightly doped region may substantially correspond to an active (or channel) of the transistor.

A source S, an active A, and a drain D of the transistor TR may be formed from a semiconductor pattern. A first insulating layer INS1 may be disposed on the semiconductor pattern. A gate G of the transistor TR may be disposed on the first insulating layer INS1. A second insulating layer INS2 may be disposed on the gate G. A third insulating layer INS3 may be disposed on the second insulating layer INS2.

A connection electrode CNE may include a first connection electrode CNE1 and a second connection electrode CNE2 to connect the transistor TR and the light-emitting element OLED. The first connection electrode CNE1 may be disposed on the third insulating layer INS3 and connected to the drain D through a first contact hole CH1 defined in the first to third insulating layers INS1 to INS3.

A fourth insulating layer INS4 may be disposed on the first connection electrode CNE1. A fifth insulating layer INS5 may be disposed on the fourth insulating layer INS4. The second connection electrode CNE2 may be disposed on the fifth insulating layer INS5. The second connection electrode CNE2 may be connected to the first connection electrode CNE1 through a second contact hole CH2 defined in the fourth and fifth insulating layers INS4 and INS5.

A sixth insulating layer INS6 may be disposed on the second connection electrode CNE2. Layers from the buffer layer BFL up to the sixth insulating layer INS6 may be a circuit element layer DP-CL. The first insulating layer INS1 to the sixth insulating layer INS6 may be an inorganic layer or an organic layer.

The first electrode AE may be disposed on the sixth insulating layer INS6. The first electrode AE may be connected to the second connection electrode CNE2 through a third contact hole CH3 defined in the sixth insulating layer INS6. A pixel-defining film PDL having defined therein an opening PX_OP for exposing a predetermined portion of the first electrode AE may be disposed on the first electrode AE and the sixth insulating layer INS6.

The hole control layer HCL may be disposed on the first electrode AE and the pixel-defining film PDL. The hole control layer HCL may include a hole transport layer and a hole injection layer.

The emission layer EML may be disposed on the hole control layer HCL. The emission layer EML may be disposed in a region corresponding to the opening PX_OP. The emission layer EML may include an organic material and/or an inorganic material. The emission layer EML may generate light having any one of red, green, and blue colors.

The electron control layer ECL may be disposed on the emission layer EML and the hole control layer HCL. The electron control layer ECL may include an electron transport layer and an electron injection layer. The hole control layer HCL and the electron control layer ECL may be disposed in common in the light-emitting region PA and the non-light-emitting region NPA.

The second electrode CE may be disposed on the electron control layer ECL. The second electrode CE may be disposed in common in the pixels PX. A layer in which the light-emitting element OLED is disposed may be a display element layer DP-OLED.

A thin-film encapsulation layer TFE may be disposed on the second electrode CE and cover the pixel PX. The thin-film encapsulation layer TFE may include a first encapsulation layer EN1 disposed on the second electrode CE, a second encapsulation layer EN2 disposed on the first encapsulation layer EN1, and a third encapsulation layer EN3 disposed on the second encapsulation layer EN2.

The first and third encapsulation layers EN1 and EN3 may include an inorganic insulating layer and may protect the pixel PX from moisture/oxygen. The second encapsulation layer EN2 may include an organic insulating layer and protect the pixel PX from foreign substances such as dust particles.

A first voltage may be applied to the first electrode AE through the transistor TR, and a second voltage having a lower level than the first voltage may be applied to the second electrode CE. A hole and an electron injected into the emission layer EML may combine to form an exciton, and as the exciton transitions to a ground state, the light-emitting element OLED may emit light.

An input sensing part ISP may be disposed on the thin-film encapsulation layer TFE. The input sensing part ISP may be directly manufactured on an upper surface of the thin-film encapsulation layer TFE.

A base layer BSL may be disposed on the thin-film encapsulation layer TFE. The base layer BSL may include an inorganic insulating layer. At least one inorganic insulating layer may be provided on the thin-film encapsulation layer TFE as the base layer BSL.

The input sensing part ISP may include a first conductive pattern CTL1 and a second conductive pattern CTL2 disposed on the first conductive pattern CTL1. The first conductive pattern CTL1 may be disposed on the base layer BSL. An insulating layer TINS may be disposed on the base layer BSL and may cover the first conductive pattern CTL1. The insulating layer TINS may include an inorganic insulating layer or an organic insulating layer. The second conductive pattern CTL2 may be disposed on the insulating layer TINS.

The first and second conductive patterns CTL1 and CTL2 may overlap the non-light-emitting region NPA. The first and second conductive patterns CTL1 and CTL2 may be disposed on the non-light-emitting region NPA between light-emitting regions PA and may have a mesh shape.

The first and second conductive patterns CTL1 and CTL2 may form sensors of the input sensing part ISP described above. For example, the first and second conductive patterns CTL1 and CTL2 having a mesh shape may be separated from each other in a predetermined region to form the sensors. A portion of the second conductive pattern CTL2 may be connected to the first conductive pattern CTL1.

An anti-reflective layer RPL may be disposed on the second conductive pattern CTL2. The anti-reflective layer RPL may include a black matrix BM and a plurality of color filters CF. The black matrix BM may overlap the non-light-emitting region NPA, and the color filters CF may respectively overlap the light-emitting regions PA.

The black matrix BM may be disposed on the insulating layer TINS and may cover the second conductive pattern CTL2. An opening B_OP overlapping the light-emitting region PA and the opening PX_OP may be defined in the black matrix BM. The black matrix BM may absorb and/or block light. A width of the opening B_OP may be greater than a width of the opening PX_OP.

The color filters CF may be disposed on the insulating layer TINS and the black matrix BM. The color filters CF may be respectively disposed in openings B_OP. A planarization insulating layer PINS may be disposed on the color filters CF. The planarization insulating layer PINS may provide a flat upper surface.

When external light travelling toward a display panel DP is reflected on the display panel DP and provided back to an external user, the user may view the external light as in the case of viewing light reflected from a mirror. To prevent such a phenomenon, by way of example, the anti-reflective layer RPL may include a plurality of color filters CF that display the same color as that of the pixels PX of the display panel DP. The color filters CF may filter external light to the same color as that of the pixels PX. In such a case, the external light might not be visible to a user.

However, an embodiment of the inventive concept is not necessarily limited thereto, and the anti-reflective layer RPL may include a polarizing film to reduce reflectance for external light. The polarizing film may be manufactured separately and attached to the input sensing part ISP through an adhesive layer. The polarizing film may include a retarder and/or a polarizer.

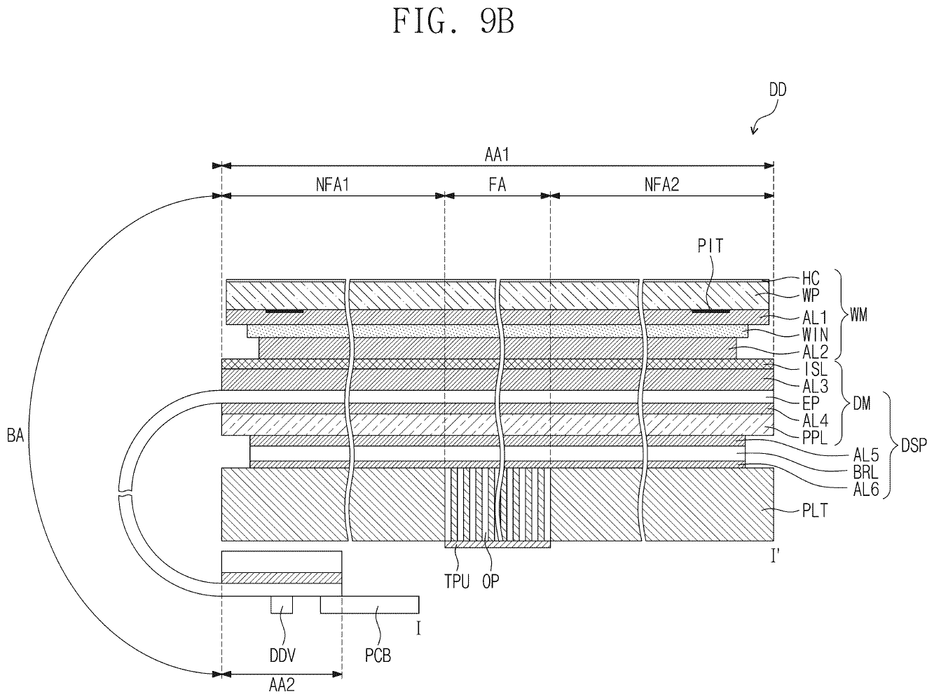

FIGS. 9A and 9B are cross-sectional views of a display device according to an embodiment of the inventive concept. FIG. 9A illustrates a cross section of a display device DD taken along line I-I′ illustrated in FIG. 7. FIG. 9B illustrates a cross section of the display device DD in a state in which a bending region BA illustrated in FIG. 9A is bent. A folding axis FX illustrated in FIG. 9A is the same as the folding axis FX of FIG. 2A, and thus to the extent that an element is not described in detail with respect to this figure, it may be understood that the element is at least similar to a corresponding element that has been described elsewhere within the present disclosure.

The display device DD may include a display part DSP, a window module WM disposed on the display part DSP, a support plate PLT disposed below the display part DSP, and a cover layer TPU. The support plate PLT may support a display module DM. The window module WM may include a window WIN, a window protective layer WP, a hard coating layer HC, and first and second adhesive layers AL1 and AL2.

The display part DSP may include an electronic panel EP, an impact absorbing layer ISL, a panel protective layer PPL, a barrier layer BRL, and third to sixth adhesive layers AL3 to AL6. The impact absorbing layer ISL, the electronic panel EP, the panel protective layer PPL, the third adhesive layer AL3, and the fourth adhesive layer AL4 may be the display module DM. The configurations of the electronic panel EP and the panel protective layer PPL here may be understood to be at least similar to corresponding elements described above in detail with reference to FIG. 5.

The impact absorbing layer ISL may be disposed on the electronic panel EP. The impact absorbing layer ISL may protect the electronic panel EP by absorbing an external impact applied from above the display device DD toward the electronic panel EP. The impact absorbing layer ISL may be manufactured in a form of a stretchable film.

The impact absorbing layer ISL may include a flexible plastic material. The flexible plastic material may be a synthetic resin film. For example, the impact absorbing layer ISL may include a flexible plastic material such as polyimide or polyethylene terephthalate.

The window WIN may be disposed on the impact absorbing layer ISL. The window WIN may protect the electronic panel EP from external scratches. The window WIN may have an optically transparent property. The window WIN may include glass. However, an embodiment of the inventive concept is not necessarily limited thereto, and the window WIN may include a synthetic resin film.

The window WIN may have a multi-layered structure or a single-layered structure. For example, the window WIN may include a plurality of synthetic resin films coupled by an adhesive or include a glass substrate and a synthetic resin film coupled by an adhesive.

The window protective layer WP may be disposed on the window WIN. The window protective layer WP may include a flexible plastic material such as polyimide or polyethylene terephthalate. The hard coating layer HC may be disposed on an upper surface of the window protective layer WP.

A printed layer PIT may be disposed on a lower surface of the window protective layer WP. The printed layer PIT may have a black color, but a color of the printed layer PIT is not necessarily limited thereto. The printed layer PIT may be adjacent to an edge of the window protective layer WP.

The barrier layer BRL may be disposed below the panel protective layer PPL. The barrier layer BRL may increase resistance to compressive force due to external pressing. Thus, the barrier layer BRL may serve to prevent deformation of the electronic panel EP. The barrier layer BRL may include a flexible plastic material such as polyimide or polyethylene terephthalate.

The barrier layer BRL may have a color that absorbs light. For example, the barrier layer BRL may have a black color. In such a case, when the display module DM is viewed from above the display module DM, components disposed below the barrier layer BRL might not be visible.

The first adhesive layer AL1 may be disposed between the window protective layer WP and the window WIN. The window protective layer WP and the window WIN may be coupled to each other by the first adhesive layer AL1. The first adhesive layer AL1 may cover the printed layer PIT.

The second adhesive layer AL2 may be disposed between the window WIN and the impact absorbing layer ISL. The window WIN and the impact absorbing layer ISL may be coupled to each other by the second adhesive layer AL2.

The third adhesive layer AL3 may be disposed between the impact absorbing layer ISL and the electronic panel EP. The impact absorbing layer ISL and the electronic panel EP may be coupled to each other by the third adhesive layer AL3.

The fourth adhesive layer AL4 may be disposed between the electronic panel EP and the panel protective layer PPL. The electronic panel EP and the panel protective layer PPL may be coupled to each other by the fourth adhesive layer AL4.

The fifth adhesive layer AL5 may be disposed between the panel protective layer PPL and the barrier layer BRL. The panel protective layer PPL and the barrier layer BRL may be coupled to each other by the fifth adhesive layer AL5.

The sixth adhesive layer AL6 may be disposed between the barrier layer BRL and the support plate PLT. For example, the support plate PLT may be disposed below the barrier layer BRL, and the sixth adhesive layer AL6 may be disposed between the barrier layer BRL and the support plate PLT. The sixth adhesive layer AL6 may overlap the first and second non-folding regions NFA1 and NFA2 and the folding region FA. The barrier layer BRL and the support plate PLT may be coupled to each other by the sixth adhesive layer AL6. Hereinafter, the sixth adhesive layer AL6 may be an upper adhesive layer AL6.

The first to sixth adhesive layers AL1, AL2, AL3, AL4, AL5, and AL6 may include a pressure sensitive adhesive (PSA) or a transparent adhesive such as an optically clear adhesive (OCA), but a type of an adhesive is not necessarily limited thereto.

A thickness of the panel protective layer PPL may be smaller than a thickness of the window protective layer WP, and a thickness of the barrier layer BRL may be smaller than the thickness of the panel protective layer PPL. A thickness of the electronic panel EP may be smaller than the thickness of the barrier layer BRL and may be equal to a thickness of the window WIN. A thickness of the impact absorbing layer ISL may be smaller than the thickness of the electronic panel EP.

A thickness of the first adhesive layer AL1 may be equal to the thickness of the barrier layer BRL, and a thickness of each of the second adhesive layer AL2 and the third adhesive layer AL3 may be equal to the thickness of the panel protective layer PPL. A thickness of the fourth adhesive layer AL4 may be equal to a thickness of the fifth adhesive layer AL5.

The thickness of each of the fourth adhesive layer AL4 and the fifth adhesive layer AL5 may be smaller than the thickness of the electronic panel EP and may be greater than the thickness of the impact absorbing layer ISL. A thickness of the sixth adhesive layer AL6 may be smaller than the thickness of the impact absorbing layer ISL. A thickness of the hard coating layer HC may be smaller than the thickness of the sixth adhesive layer AL6.

The electronic panel EP, the impact absorbing layer ISL, the panel protective layer PPL, and the third and fourth adhesive layers AL3 and AL4 may have the same width. The window protective layer WP and the first adhesive layer AL1 may have the same width. The barrier layer BRL and the fifth and sixth adhesive layers AL5 and AL6 may have the same width.

Widths of the electronic panel EP, the impact absorbing layer ISL, the panel protective layer PPL, and the third and fourth adhesive layers AL3 and AL4 may be greater than widths of the window protective layer WP and the first adhesive layer AL1. Edges of the electronic panel EP, the impact absorbing layer ISL, the panel protective layer PPL, and the third and fourth adhesive layers AL3 and AL4 may be disposed further outward than edges of the window protective layer WP and the first adhesive layer AL1.

Widths of the window WIN and the second adhesive layer AL2 may be smaller than the widths of the window protective layer WP and the first adhesive layer AL1. The width of the second adhesive layer AL2 may be smaller than the width of the window WIN. An edge of the window WIN may be disposed further inward than the edges of the window protective layer WP and the first adhesive layer AL1. An edge of the second adhesive layer AL2 may be disposed further inward than the edge of the window WIN.

Widths of the barrier layer BRL and the fifth and sixth adhesive layers AL5 and AL6 may be smaller than the widths of the window protective layer WP and the first adhesive layer AL1. Edges of the barrier layer BRL and the fifth and sixth adhesive layers AL5 and AL6 may be disposed further inward than the edges of the window protective layer WP and the first adhesive layer AL1.

The support plate PLT may be disposed below the display part DSP and support the display part DSP. The support plate PLT may be disposed below the electronic panel EP and support the electronic panel EP. A width of the support plate PLT may be substantially equal to the width of the electronic panel EP. The support plate PLT may have greater rigidity than the display part DSP.

The support plate PLT may include a non-metal material. For example, the support plate PLT may include a fiber reinforced composite. The fiber reinforced composite may be carbon fiber reinforced plastic (CFRP) or glass fiber reinforced plastic (GFRP).

The support plate PLT may include a fiber reinforced composite so as to be reduced in weight. The support plate PLT may include a fiber reinforced composite, and may thus be lighter than a metal support plate including a metal material and have a modulus and strength similar to those of the metal support plate. In addition, the support plate PLT may include a fiber reinforced composite, and shape processing of the support plate PLT may thus be easier compared to the metal support plate. For example, the support plate PLT including a fiber reinforced composite may be more easily processed through a laser process or a micro-blast process. However, this is an example, and an embodiment of the inventive concept is not necessarily limited thereto, and the support plate PLT may include a metal material.

The support plate PLT may include a first non-folding part PLT1, a folding part PLF, and a second non-folding part PLT2. The first non-folding part PLT1 may overlap the first non-folding region NFA1. The folding part PLF may overlap the folding region FA. The second non-folding part PLT2 may overlap the second non-folding region NFA2.

A plurality of openings OP may be defined in the folding part PLF. The openings OP may be formed by penetrating portions of the support plate PLT in the third direction DR3. When viewed from the second direction DR2, the openings OP may be spaced apart from one another in the first direction DR1. The openings OP may be formed through the laser process or the micro-blast process described above. A width of a portion in which the openings OP are formed may be smaller than a width of an open portion of the sixth adhesive layer AL6.

Since the openings OP are defined in a portion of the support plate PLT overlapping the folding region FA, flexibility of the portion of the support plate PLT overlapping the folding region FA may be increased. As a result, the support plate PLT may be folded with respect to the folding region FA.

The cover layer TPU may be disposed on a lower surface PLT-L of the support plate PLT. The cover layer TPU may be disposed on a lower surface of the folding part PLF. The cover layer TPU may overlap the openings OP. The cover layer TPU may cover the openings OP under the folding part PLF. A width of a portion in which the openings OP are formed may be equal to a width of the cover layer TPU. The cover layer TPU may prevent moisture, foreign substances, and the like from being introduced into the openings OP.

The display device DD may further include a digitizer, a shielding layer, and a heat dissipation layer which are disposed below the support plate PLT.

Referring to FIG. 9B, the panel protective layer PPL and the fourth adhesive layer AL4 might not be disposed below the bending region BA. The panel protective layer PPL and the fourth adhesive layer AL4 may be disposed below a second non-bending region AA2 of the electronic panel EP. The data driver DDV may be disposed below the second non-bending region AA2 of the electronic panel EP.

A printed circuit board PCB may be connected to the second non-bending region AA2 of the electronic panel EP. The printed circuit board PCB may be connected to one side of the second non-bending region AA2. The bending region BA may be bent such that the second non-bending region AA2 may be disposed below a first non-bending region AA1. Thus, the data driver DDV and the printed circuit board PCB may be disposed below the first non-bending region AA1.

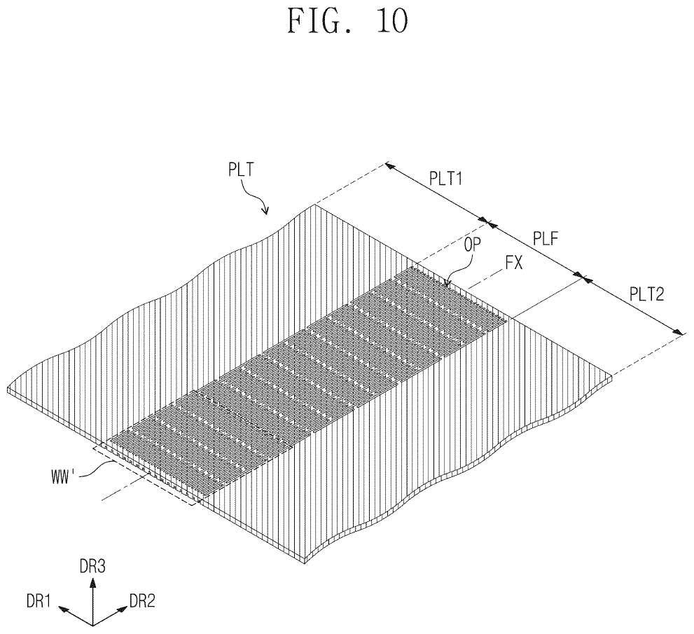

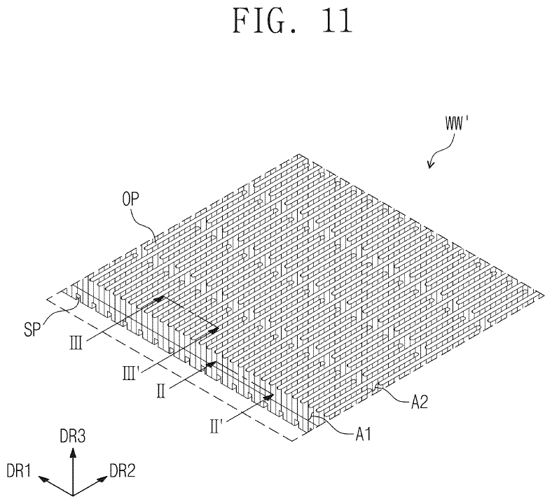

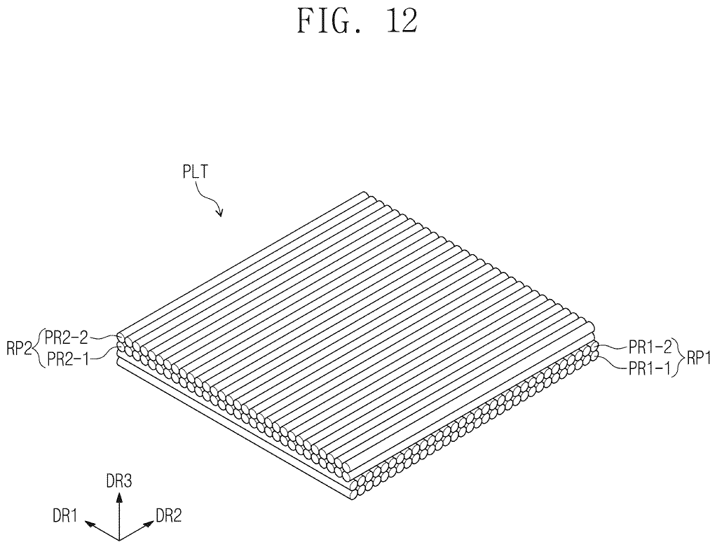

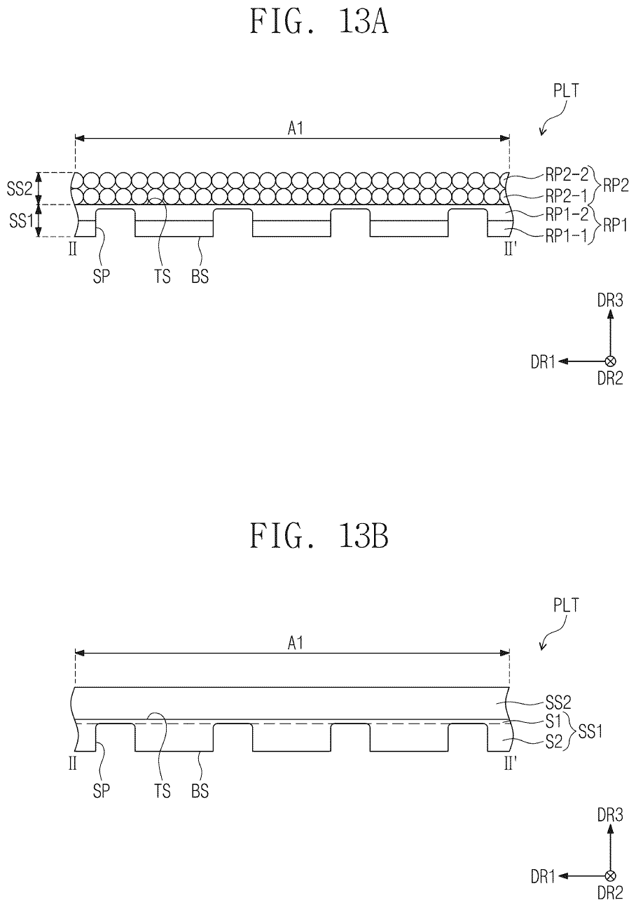

FIGS. 10 and 12 are perspective views of a support plate according to an embodiment of the inventive concept. FIG. 11 is an enlarged perspective view of a support plate according to an embodiment of the inventive concept. FIGS. 13A to 13D are cross-sectional views of a support plate according to an embodiment of the inventive concept.

FIGS. 10 and 12 illustrate perspective views of the support plate PLT illustrated in FIGS. 9A and 9B. FIG. 12 illustrates a stacked structure of fibers RP1 and RP2 constituting the support plate PLT in more detail. For convenience of description, a specific illustration of a component such as an opening OP (see FIG. 10) is not provided in FIG. 12. FIG. 11 is an enlarged perspective view of region WW′ illustrated in FIG. 10. FIGS. 13A and 13B each illustrate a cross section of the support plate PLT taken along line II-II′ illustrated in FIG. 11. FIG. 13A illustrates a stacked structure of fibers RP1 and RP2 constituting the support plate PLT in more detail, and FIG. 13B illustrates a stacked structure of first and second portions S1 and S2 constituting the support plate PLT in more detail. FIG. 13C illustrates a cross section of the support plate PLT taken along line III-III′ illustrated in FIG. 11. FIG. 13D illustrates a cross section of a support plate PLT-1 according to an embodiment of the inventive concept.

Referring to FIGS. 10 and 11, in a plan view, the support plate PLT may have a substantially rectangular shape having a pair of short sides extending in the first direction DR1 and a pair of long sides extending in the second direction DR2. However, this is an example, and a shape of the support plate PLT may be different from what is described herein.

The support plate PLT may include the first non-folding part PLT1, the folding part PLF, and the second non-folding part PLT2. The folding part PLF may be disposed between the first non-folding part PLT1 and the second non-folding part PLT2. The first non-folding part PLT1, the folding part PLF, and the second non-folding part PLT2 may be arranged in the first direction DR1. The first non-folding part PLT1 and the second non-folding part PLT2 may overlap the first non-folding region NFA1 and the second non-folding region NFA2 illustrated in FIGS. 7 and 9A. The folding part PLF may overlap the folding region FA illustrated in FIGS. 7 and 9A.

By way of example, the first non-folding part PLT1 and the second non-folding part PLT2 may each have a quadrangular shape parallel to a plane defined by the first direction DR1 and the second direction DR2. However, an embodiment of the inventive concept is not necessarily limited thereto, and shapes of the first and second non-folding parts PLT1 and PLT2 may be different from what is described herein.

A lattice pattern may be defined in the folding part PLF. For example, a plurality of openings OP may be defined in the folding part PLF. The openings OP may be arranged in accordance with a predetermined rule. The openings OP may be arranged in a lattice shape and may form a lattice pattern in the folding part PLF.

The openings OP may be arranged in the first direction DR1 and the second direction DR2. In a plan view, the openings OP adjacent to each other in the first direction DR1 may be arranged in a staggered manner. The openings OP may extend longer in the second direction DR2 than in the first direction DR1. That is, the openings OP may extend in a direction of a folding axis FX.

The folding part PLF may include a plurality of branch portions extending in the first direction DR1 and a plurality of support portions extending in the second direction DR2. The support portions may be disposed between the openings OP adjacent to each other in the first direction DR1. The branch portions may be disposed between the openings OP adjacent to each other in the second direction DR2. The branch portions may connect the support portions adjacent in the first direction DR1.

The folding part PLF may include a first region A1 and a second region A2 adjacent to the first region A1. The first region A1 may mean a region in which a plurality of recess patterns SP are defined, and the second region A2 may mean a region in which the plurality of openings OP are defined. The plurality of recess patterns may be defined in the first region, and the plurality of first openings may be defined in the second region.

Referring to FIGS. 11 and 13A, the support plate PLT may include a plurality of fibers RP1 and RP2 stacked in the third direction DR3. The support plate PLT may include carbon fiber reinforced plastic (CFRP) or glass fiber reinforced plastic (GFRP), and in the present disclosure, the fibers RP1 and RP2 may refer to the carbon fiber reinforced plastic (CFRP) or the glass fiber reinforced plastic (GFRP).

The support plate PLT may include a first layer SS1 and a second layer SS2 disposed on the first layer SS1. The first layer SS1 includes a plurality of first fibers RP1, and the second layer SS2 includes a plurality of second fibers RP2.

The first fiber RP1 may extend in the first direction DR1, and the plurality of first fibers RP1 may be arranged side by side with respect to each other in the second direction DR2. In comparison, the second fiber RP2 may extend in the second direction, and the plurality of second fibers RP2 may be arranged side by side with respect to each other in the first direction DR1. For example, the second fiber RP2 may extend in the second direction DR2 parallel to the folding axis FX (see FIG. 10).

Referring to FIGS. 11, 13A, and 13B, the plurality of first fibers RP1 may include a plurality of (1-1)-th fibers RP1-1 and a plurality of (1-2)-th fibers RP1-2. The plurality of (1-2)-th fibers RP1-2 may be disposed on the plurality of (1-1)-th fibers RP1-1. The (1-2)-th fiber RP1-2 may correspond to the (1-1)-th fiber RP1-1. The plurality of second fibers RP2 may include a plurality of (2-1)-th fibers RP2-1 and a plurality of (2-2)-th fibers RP2-2. The plurality of (2-2)-th fibers RP2-2 may be disposed on the plurality of (2-1)-th fibers RP2-1. The (2-2)-th fiber RP2-2 may correspond to the (2-1)-th fiber RP2-1. However, this is illustrated to show a structure in which the first and second fibers RP1 and RP2 are stacked as multiple layers in the first and second layers SS1 and SS2 as an example, and the first and second fibers RP1 and RP2 may be stacked as three or more layers.

The first layer SS1 may mean a layer in which the plurality of recess patterns SP are defined. The first layer SS1 includes a first surface being in contact with the second layer SS2 and a second surface opposed to the first surface, and the plurality of recess patterns SP are defined in the second surface. The recess pattern SP may be recessed from the first surface toward the second surface. For example, the support plate PLT may have a structure in which the second layer SS2 is directly disposed on the first layer SS1, a first upper surface TS of the first layer SS1 is in contact with the second layer SS2, and the plurality of recess patterns SP are defined in a first lower surface BS of the first layer SS1. The plurality of recess patterns SP may be recessed from the first lower surface BS of the first layer SS1 toward the second layer SS2. In the recess pattern SP, the (1-1)-th fiber RP1-1 may be penetrated in the third direction DR3, and a portion of the (1-2)-th fiber RP1-2 may be recessed toward the second layer SS2. However, an embodiment is not necessarily limited thereto, and unlike the illustration, a portion of the (1-1)-th fiber RP1-1 may be recessed toward the second layer SS2 in the third direction DR3 in the recess pattern SP, and the recess pattern SP might not be defined in the (1-2)-th fiber RP1-2. Alternatively, in a case in which the first layer SS1 has a structure in which the plurality of first fibers RP1 are stacked as n layers (here, “n” is an integer equal to or greater than 3), the plurality of first fibers RP1 may include (1-1)-th to (1-n)-th fibers RP1-1 to RP1-n, and in this case, a portion of the (1-1)-th fiber RP1-1 may be recessed toward the second layer SS2 in the third direction DR3 in the recess pattern SP, and the recess pattern SP might not be defined in the (1-2)-th to (1-n)-th fibers RP1-2 to RP1-n. Alternatively, (1-1)-th to (1-n-1)-th fibers RP1-1 to RP1-n-1 may be penetrated, and a portion of the (1-n)-th fiber RP1-n may be recessed toward the second layer SS2, and an embodiment is not necessarily limited thereto.

The first layer SS1 may include the first portion S1 and the second portion S2. The first portion S1 may be a portion adjacent to the second layer SS2 in the third direction DR3. The second portion S2 may be a portion spaced apart from the second layer SS2 with the first portion S1 therebetween in a cross-sectional view. The recess pattern SP may penetrate the second portion S2 and expose one surface of the first portion S1. The recess pattern SP might not be defined in the first portion S1. For example, the support plate PLT may have a structure in which the first portion S1 is disposed on the second portion S2, the second layer SS2 is disposed on the first layer SS1, and the recess pattern SP penetrates the second portion S2 and exposes a lower surface of the first portion S1. The second portion S2 may include a portion of the (1-2)-th fiber RP1-2 and the (1-1)-th fiber RP1-1, and the first portion S1 may include another portion of the (1-2)-th fiber RP1-2, but an embodiment is not necessarily limited thereto.

Referring to FIGS. 11, 13A, and 13C, the support plate PLT may include a first region A1 and a second region A2 adjacent to the first region A1. In an embodiment, the folding part PLF (see FIG. 10) may include the first region A1 and the second region A2. The first region A1 may mean a region in which the plurality of recess patterns SP are defined, and the second region A2 may mean a region in which the plurality of openings OP are defined. The first region A1 may overlap a portion of the non-display region NDA (see FIG. 1). The first region A1 may be defined to be adjacent to an edge of the electronic device ED (see FIG. 1).

The opening OP may include a first opening OP1 defined in the first layer SS1 and a second opening OP2 defined in the second layer SS2. The recess pattern SP may be formed in correspondence to the first opening OP1. The recess pattern SP may have a shape extending from the first opening OP1 in a first horizontal direction, and the plurality of recess patterns SP may be arranged side by side with respect to each other in a second horizontal direction crossing the first horizontal direction in a plan view. For example, the recess pattern SP may have a shape extending from the first opening OP1 in the second direction DR2, and the plurality of recess patterns SP may be arranged side by side with respect to each other in the first direction DR1. However, an embodiment of the inventive concept is not necessarily limited thereto, and if necessary, the plurality of recess patterns SP may be arranged side by side with respect to each other in the second direction DR2, and the recess pattern SP may have a shape extending from the first opening OP1 in the first direction DR1.

The recess pattern SP might not be defined in a portion of the first layer SS1 and the second layer SS2 overlapping the second region A2. The recess pattern SP might not be defined in the first portion S1 (see FIG. 13B) of the first layer SS1 overlapping the second region A2 and the second layer SS2 overlapping the second region A2. Even if the second layer SS2 in which the recess pattern SP is not defined is included in the folding part PLF (see FIG. 10), since an extension direction DR2 of the second layer SS2 is parallel to the folding axis FX (see FIG. 10) and the second layer SS2 has a relatively small modulus value when being folded, foldability of at least a certain level may be provided. Alternatively, a portion of the second fiber RP2 included in the second layer SS2 overlapping the second region A2 and the first fiber RP1 included in the first portion S1 (see FIG. 13B) of the first layer SS1 overlapping the second region A2 may have a cut shape. Since the second fiber RP2 and the first fiber RP1 having a cut shape are included, foldability of at least a certain level may be provided.

Referring to FIG. 13D, the support plate PLT-1 may include a first layer SS1, a second layer SS2 disposed on the first layer SS1, and a lower layer DSL disposed under the first layer SS1.

The lower layer DSL may include a plurality of third fibers RP3. The third fiber RP3 may extend in the second direction DR2, and the plurality of third fibers RP3 may be arranged side by side with respect to each other in the first direction DR1. The plurality of third fibers RP3 may be arranged in the same direction as a plurality of second fibers RP2 and in a direction perpendicular to a plurality of first fibers RP1 in a plan view.

A plurality of recess patterns SP may be defined in the first lower surface BS of the first layer SS1, and a plurality of lower holes HH1 corresponding to the plurality of recess patterns SP may be defined in the lower layer DSL. The lower hole HH1 may have a shape connected to the recess pattern SP in a cross-sectional view. However, this is illustrated to show a structure in which the support plate PLT-1 is stacked as three or more layers SS1, SS2, and DS as an example, and the support plate PLT-1 may include a structure in which four or more layers are stacked. In a case in which the support plate PLT-1 is stacked as three or more layers, arrangement directions of adjacent layers may be perpendicular to each other in a plan view.

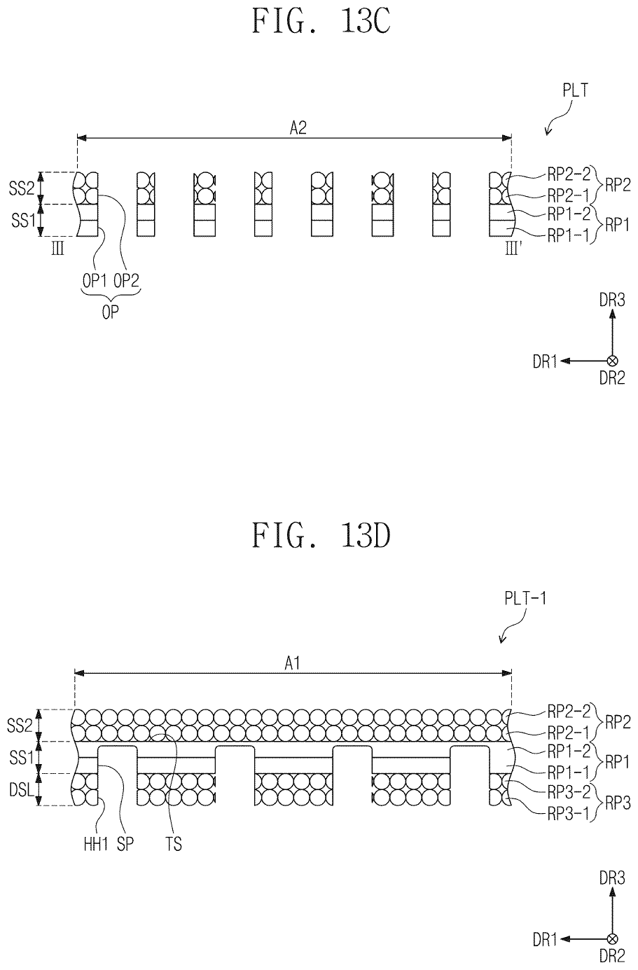

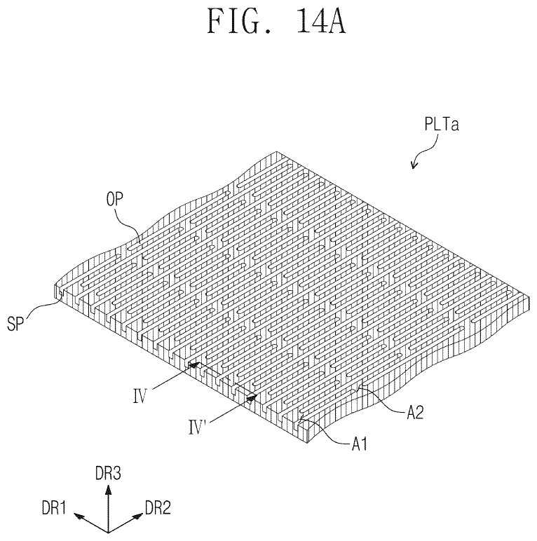

FIG. 14A is an enlarged perspective view of a support plate according to an embodiment of the inventive concept. FIGS. 14B and 14C are cross-sectional views of a support plate according to an embodiment of the inventive concept.

FIG. 14A illustrates an enlarged perspective view of a support plate PLTa according to an embodiment of the inventive concept, which corresponds to FIG. 12. FIG. 14B illustrates a cross section of the support plate PLTa taken along line IV-IV′ illustrated in FIG. 14A. FIG. 14C illustrates a cross section of a support plate PLTa-1 according to an embodiment of the inventive concept. To the extent that an element is not described in detail with respect to this figure, it may be understood that the element is at least similar to a corresponding element that has been described elsewhere within the present disclosure.

Referring to FIGS. 14A and 14B, the support plate PLTa may include a first layer SS1a and a second layer SS2a disposed on the first layer SS1a. The first layer SS1a includes a plurality of first fibers RP1a, and the second layer SS2a includes a plurality of second fibers RP2a. The plurality of first fibers RP1a may include a plurality of (1-1)-th fibers RP1a-1 and a plurality of (1-2)-th fibers RP1a-2, and the plurality of second fibers RP2a may include a plurality of (2-1)-th fibers RP2a-1 and a plurality of (2-2)-th fibers RP2a-2.

The support plate PLTa may have a structure in which the second layer SS2a is directly disposed under the first layer SS1a, a first lower surface BS of the first layer SS1a is in contact with the second layer SS2a, and a plurality of recess patterns SP are defined in a first upper surface TS of the first layer SS1a. The plurality of recess patterns SP may be recessed from the first upper surface TS of the first layer SS1a toward the second layer SS2a.

Referring to FIG. 14C, the support plate PLTa-1 may include a first layer SS1a, a second layer SS2a disposed under the first layer SS1a, and an upper layer US disposed on the first layer SS1a.

The upper layer US may include a plurality of fourth fibers RP4. The fourth fiber RP4 may extend in the second direction DR2, and the plurality of fourth fibers RP4 may be arranged side by side with respect to each other in the first direction DR1. The plurality of fourth fibers RP4 may be arranged in the same direction as a plurality of second fibers RP2a and in a direction perpendicular to a plurality of first fibers RP1a in a plan view.

A plurality of recess patterns SP may be defined in a first upper surface TS of the first layer SS1a, and a plurality of upper holes HH2 corresponding to the plurality of recess patterns SP may be defined in the upper layer US. The upper hole HH2 may have a shape connected to the recess pattern SP in a cross-sectional view. The support plate PLTa-1 may include a structure in which four or more layers are stacked, and in this case, arrangement directions of adjacent layers may be perpendicular to each other in a plan view.

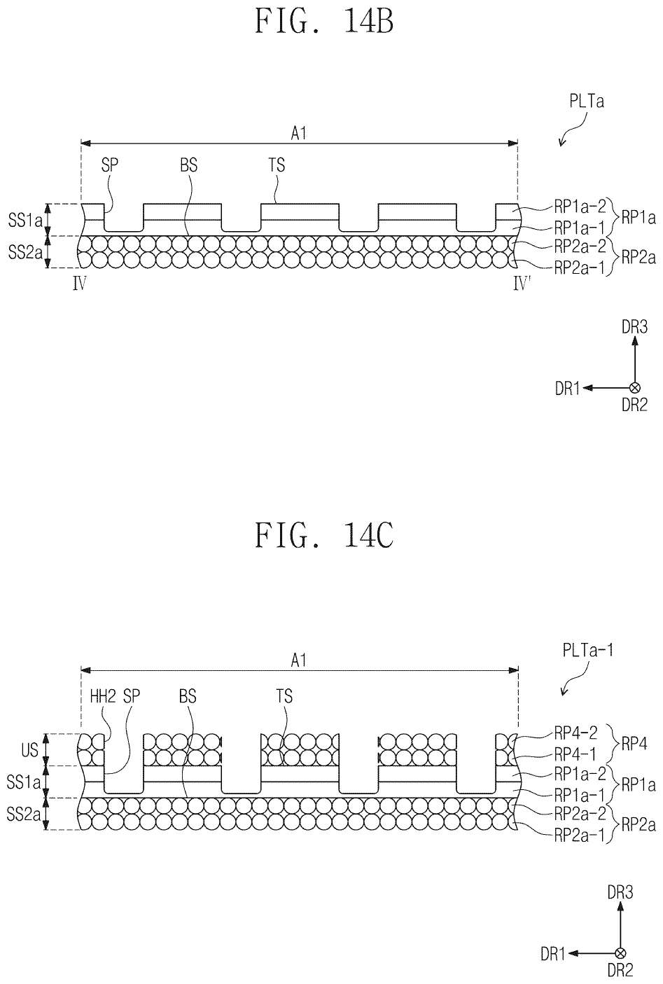

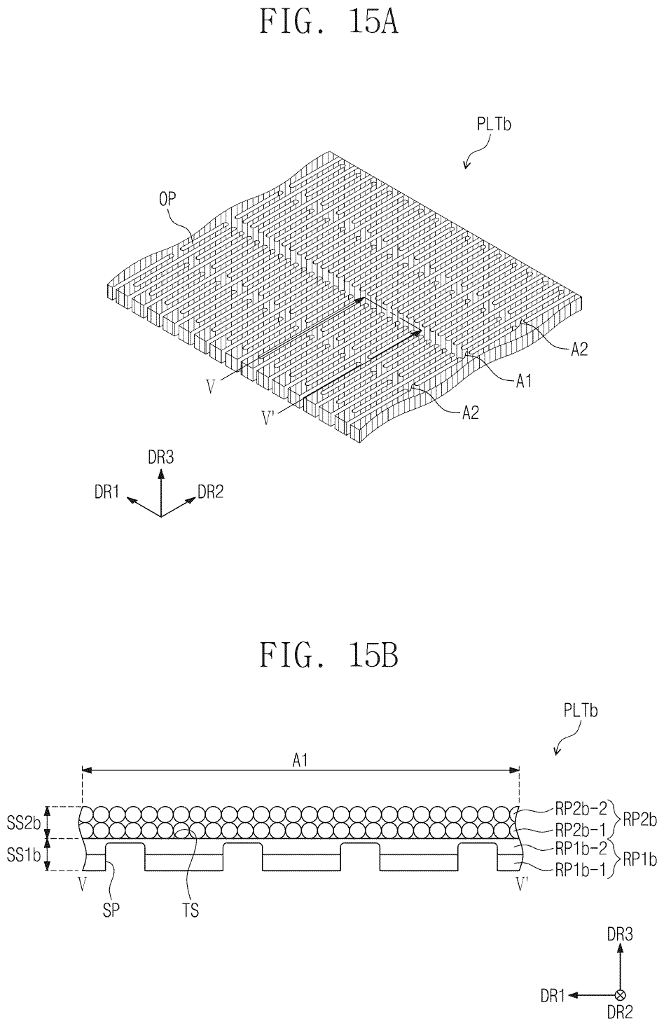

FIG. 15A is an enlarged perspective view of a support plate according to an embodiment of the inventive concept. FIG. 15B is a cross-sectional view of a support plate according to an embodiment of the inventive concept. To the extent that an element is not described in detail with respect to this figure, it may be understood that the element is at least similar to a corresponding element that has been described elsewhere within the present disclosure.

FIG. 15A illustrates an enlarged perspective view of a support plate PLTb according to an embodiment of the inventive concept, which corresponds to FIG. 12. FIG. 15B illustrates a cross section of the support plate PLTb taken along line V-V′ illustrated in FIG. 15A.

Referring to FIGS. 15A and 15B, the support plate PLTb may include a first layer SS1b and a second layer SS2b disposed on the first layer SS1b. The first layer SS1b includes a plurality of first fibers RP1b, and the second layer SS2b includes a plurality of second fibers RP2b. The plurality of first fibers RP1b may include a plurality of (1-1)-th fibers RP1b-1 and a plurality of (1-2)-th fibers RP1b-2, and the plurality of second fibers RP2b may include a plurality of (2-1)-th fibers RP2b-1 and a plurality of (2-2)-th fibers RP2b-2.

The support plate PLTb may include a first region A1 and a second region A2 adjacent to the first region A1. In the support plate PLTb, the first region A1 may overlap a portion of the display region DA (see FIG. 1). Compared to FIGS. 13A-13D described above, in FIG. 15A, in the support plate PLTb, the first region A1 may be defined not to be adjacent to an edge of the electronic device ED (see FIG. 1) but to be adjacent to a center portion of the electronic device ED (see FIG. 1).

An electronic device, according to an embodiment of the inventive concept, includes a support plate, and the support plate includes a first layer which includes a plurality of first fibers and in which a recess pattern is defined and a second layer which includes a plurality of second fibers and in which a recess pattern is not defined. The electronic device, according to an embodiment of the inventive concept, may include an opening overlapping a folding region, and a process of manufacturing the electronic device, according to an embodiment of the inventive concept, may include an operation in which a lattice pattern of the opening may be deformed. However, in the electronic device, according to an embodiment of the inventive concept, since the recess pattern is not defined in the second layer, the second layer may serve as a bridge connecting a first non-folding part and a second non-folding part. Accordingly, the electronic device, according to an embodiment of the inventive concept, may maintain folding reliability, and an operation of installing a separate bridge may be skipped in a process of manufacturing the electronic device, and thus a cutting mark on the device may be reduced, and process efficiency may be increased.

Since an electronic device according to an embodiment of the inventive concept includes a support plate including a first layer and a second layer, folding reliability may be maintained, and process efficiency in manufacturing the electronic device may be increased.

Although description has been made with reference to the embodiments of the inventive concept, it is understood that the inventive concept should not necessarily be limited to these embodiments, but various changes and modifications may be made by one ordinary skilled in the art within the spirit and scope of the inventive concept. In addition, embodiments disclosed herein are not necessarily intended to limit the technical spirit of the inventive concept, and all technical ideas within the scope of the following claims and their equivalents should be construed as being included in the scope of the inventive concept.

What is claimed is:

1. An electronic device, comprising:
a display panel including a first non-folding region, a second non-folding region, and a folding region disposed between the first non-folding region and the second non-folding region; and
a support plate disposed below the display panel and including a plurality of openings overlapping the folding region,
wherein the support plate includes:
a first layer including a plurality of first fibers each extending in a first direction and arranged side by side with respect to each other in a second direction that is perpendicular to the first direction, and
a second layer disposed either above or below the first layer and including a plurality of second fibers each extending in the second direction and arranged side by side with respect to each other in the first direction,
wherein the first layer includes a first surface contacting the second layer and a second surface opposite to the first surface, and
wherein a plurality of recess patterns are defined in the second surface.

2. The electronic device of claim 1, wherein the plurality of recess patterns overlap the folding region.

3. The electronic device of claim 1, wherein the plurality of recess patterns are arranged side by side with respect to each other in the first direction.

4. The electronic device of claim 1, wherein the first layer comprises a first portion adjacent to the second layer and a second portion that is spaced apart from the second layer with the first portion interposed therebetween, in a cross-sectional view, and
wherein each of the plurality of recess patterns penetrates the second portion and exposes one surface of the first portion.

5. The electronic device of claim 1, wherein the plurality of openings comprises:
a plurality of first openings defined in the first layer; and
a plurality of second openings defined in the second layer and respectively corresponding to the plurality of first openings.

6. The electronic device of claim 5, wherein the plurality of recess patterns respectively extend from the plurality of first openings in the second direction.

7. The electronic device of claim 1, wherein the support plate comprises a first non-folding part overlapping the first non-folding region, a second non-folding part overlapping the second non-folding region, and a folding part overlapping the folding region.

8. The electronic device of claim 7, wherein the folding part comprises a first region and a second region adjacent to the first region,
wherein the plurality of recess patterns are defined in the first region, and
wherein the plurality of openings are defined in the second region.

9. The electronic device of claim 8, wherein an upper surface of the electronic device comprises a display region in which an image is displayed, and a non-display region which surrounds the display region and overlaps an edge of the electronic device, and
wherein the first region overlaps a portion of the non-display region.

10. The electronic device of claim 8, wherein an upper surface of the electronic device comprises a display region in which an image is displayed, and a non-display region which surrounds the display region and overlaps an edge of the electronic device, and
wherein the first region overlaps a portion of the display region.

11. The electronic device of claim 1, wherein the second layer is disposed directly on the first layer, and
wherein the plurality of recess patterns are defined in a first lower surface of the first layer.

12. The electronic device of claim 11, wherein the support plate further comprises a lower layer disposed under the first layer and including a plurality of third fibers each extending in the second direction and arranged side by side with respect to each other in the first direction, and
wherein a plurality of lower holes respectively corresponding to the plurality of recess patterns are defined in the lower layer.

13. The electronic device of claim 1, wherein the second layer is disposed directly under the first layer, and
wherein the plurality of recess patterns are defined in a first upper surface of the first layer.

14. The electronic device of claim 13, wherein the support plate further comprises an upper layer disposed on the first layer and including a plurality of fourth fibers each extending in the second direction and arranged side by side with respect to each other in the first direction, and
wherein a plurality of upper holes respectively corresponding to the plurality of recess patterns are defined in the upper layer.

15. The electronic device of claim 1, wherein the plurality of first fibers comprise a plurality of (1-1)-th fibers and a plurality of (1-2)-th fibers disposed on the plurality of (1-1)-th fibers, and
wherein the plurality of (1-2)-th fibers respectively correspond to the plurality of (1-1)-th fibers.

16. The electronic device of claim 1, wherein the plurality of second fibers comprise a plurality of (2-1)-th fibers and a plurality of (2-2)-th fibers disposed on the plurality of (2-1)-th fibers, and
wherein the plurality of (2-2)-th fibers are respectively correspond to the plurality of (2-1)-th fibers.

17. The electronic device of claim 1, further comprising an upper adhesive layer disposed between the display panel and the support plate.

18. The electronic device of claim 1, further comprising a cover layer overlapping the plurality of openings and disposed on a lower surface of the support plate.

19. The electronic device of claim 1, wherein the folding region is configured to folded and unfolded about a folding axis.

20. The electronic device of claim 19, wherein the folding axis extends in the second direction.
